(19) United States
(12) Patent Application Publication
(10) Pub. No.: US 2026/0020078 A1
(43) Pub. Date: Jan. 15, 2026

(54) ADAPTATION OF RANDOM ACCESS CHANNEL PROCEDURES

(71) Applicant: QUALCOMM Incorporated, San Diego, CA (US)

(72) Inventors: Ahmed Attia ABOTABL, San Diego, CA (US); Nazmul ISLAM, Littleton, MA (US); Hung Dinh LY, San Diego, CA (US)

(21) Appl. No.: 18/768,871

(22) Filed: Jul. 10, 2024

(51) Int. Cl. H04W 74/0836; H04W 68/02

(52) U.S. Cl. CPC H04W 74/0836; H04W 68/02

(57) ABSTRACT

Methods, systems, and devices for wireless communications are described. A user equipment (UE) may receive one or more first messages that indicate a set of parameters of a random access channel (RACH) configuration for a two-step RACH procedure for the UE. The set of parameters may indicate uplink transmission occasions of the two-step RACH procedure that are available for uplink transmission of one or more RACH preambles, one or more physical uplink shared channel (PUSCH) transmissions, or both. The UE may then receive one or more second messages that modify at least one parameter of the RACH configuration, which modifies the uplink transmission occasions allocated for transmission of the one or more RACH preambles, the one or more PUSCH transmissions, or both. The UE may then transmit one or more uplink messages based on the modification of the at least one parameter of the RACH configuration.

### FIELD OF TECHNOLOGY

The following relates to wireless communications, including adaptation of random access channel (RACH) procedures.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving one or more first messages indicative of a set of parameters of a random access configuration for a two-step random access procedure for the UE, the set of parameters indicating uplink transmission occasions of the two-step random access procedure that are available for uplink transmission of one or more random access channel (RACH) preambles, one or more PUSCHs, or both, receiving one or more second messages that modify at least one parameter of the set of parameters of the random access configuration, where modification of the at least one parameter modifies a configuration of the uplink transmission occasions allocated for transmission of the one or more RACH preambles, the one or more physical uplink shared channels (PUSCHs), or both of the two-step random access procedure, and transmitting one or more uplink messages in accordance with the modification of the at least one parameter based on the one or more second messages.

A UE for wireless communications is described. The UE may include one or more memories storing processor executable code, and one or more processors coupled with the one or more memories. The one or more processors may individually or collectively be operable to execute the code to cause the UE to receive one or more first messages indicative of a set of parameters of a random access configuration for a two-step random access procedure for the UE, the set of parameters indicating uplink transmission occasions of the two-step random access procedure that are available for uplink transmission of one or more RACH preambles, one or more PUSCHs, or both, receive one or more second messages that modify at least one parameter of the set of parameters of the random access configuration, where modification of the at least one parameter modifies a configuration of the uplink transmission occasions allocated for transmission of the one or more RACH preambles, the one or more PUSCHs, or both of the two-step random access procedure, and transmit one or more uplink messages in accordance with the modification of the at least one parameter based on the one or more second messages.

Another UE for wireless communications is described. The UE may include means for receiving one or more first messages indicative of a set of parameters of a random access configuration for a two-step random access procedure for the UE, the set of parameters indicating uplink transmission occasions of the two-step random access procedure that are available for uplink transmission of one or more RACH preambles, one or more PUSCHs, or both, means for receiving one or more second messages that modify at least one parameter of the set of parameters of the random access configuration, where modification of the at least one parameter modifies a configuration of the uplink transmission occasions allocated for transmission of the one or more RACH preambles, the one or more PUSCHs, or both of the two-step random access procedure, and means for transmitting one or more uplink messages in accordance with the modification of the at least one parameter based on the one or more second messages.

A non-transitory computer-readable medium storing code for wireless communications is described. The code may include instructions executable by one or more processors to receive one or more first messages indicative of a set of parameters of a random access configuration for a two-step random access procedure for the UE, the set of parameters indicating uplink transmission occasions of the two-step random access procedure that are available for uplink transmission of one or more RACH preambles, one or more PUSCHs, or both, receive one or more second messages that modify at least one parameter of the set of parameters of the random access configuration, where modification of the at least one parameter modifies a configuration of the uplink transmission occasions allocated for transmission of the one or more RACH preambles, the one or more PUSCHs, or both of the two-step random access procedure, and transmit one or more uplink messages in accordance with the modification of the at least one parameter based on the one or more second messages.

Some examples of the method, UEs, and non-transitory computer-readable medium described herein may further include operations, features, means, or instructions for receiving one or more third messages that activate the modification of the at least one parameter, where the one or more first messages include one or more semi-static configuration messages, one or more radio resource control (RRC) messages, or both.

In some examples of the method, UEs, and non-transitory computer-readable medium described herein, transmitting the one or more uplink messages may include operations, features, means, or instructions for transmitting the one or more uplink messages via an uplink transmission occasion of the uplink transmission occasions indicated by the set of parameters, where the uplink transmission occasion may be based on increasing or decreasing the quantity of the uplink transmission occasions.

In some examples of the method, UEs, and non-transitory computer-readable medium described herein, transmitting the one or more uplink messages may include operations, features, means, or instructions for transmitting at least one uplink random access message via an uplink transmission occasion of the uplink transmission occasions indicated by the set of parameters based on the modification of the at least one parameter.

In some examples of the method, UEs, and non-transitory computer-readable medium described herein, transmitting the one or more uplink messages may include operations, features, means, or instructions for transmitting at least one uplink shared channel message via an uplink transmission occasion of the uplink transmission occasions indicated by the set of parameters based on the modification of the at least one parameter.

In some examples of the method, UEs, and non-transitory computer-readable medium described herein, receiving the one or more second messages that modify the at least one parameter may include operations, features, means, or instructions for receiving the one or more second messages via one or more paging early indications, one or more downlink control information DCI messages, one or more paging payload messages, or any combination thereof.

In some examples of the method, UEs, and non-transitory computer-readable medium described herein, transmitting the one or more uplink messages may include operations, features, means, or instructions for transmitting the one or more uplink messages via an uplink transmission occasion of the uplink transmission occasions indicated by the set of parameters, where the uplink transmission occasion may be based on the modification periodicity.

In some examples of the method, UEs, and non-transitory computer-readable medium described herein, transmitting the one or more uplink messages may include operations, features, means, or instructions for transmitting the one or more uplink messages via an uplink transmission occasion of the uplink transmission occasions indicated by the set of parameters, where the uplink transmission occasion may be based on increasing the quantity of the uplink transmission occasions.

In some examples of the method, UEs, and non-transitory computer-readable medium described herein, the modification of the at least one parameter includes an increase in a quantity of the uplink transmission occasions allocated for transmission of the one or more RACH preambles and the method, apparatuses, and non-transitory computer-readable medium may include further operations, features, means, or instructions for receiving, based on the increase in the quantity of the uplink transmission occasions allocated for transmission of the one or more RACH preambles, a system information message that indicates a configuration for a corresponding quantity of uplink transmission occasions for the one or more PUSCHs associated with the one or more RACH preambles.

In some examples of the method, UEs, and non-transitory computer-readable medium described herein, the modification of the at least one parameter includes an increase in a quantity of the uplink transmission occasions allocated for transmission of the one or more RACH preambles and the method, apparatuses, and non-transitory computer-readable medium may include further operations, features, means, or instructions for performing a four-step random access procedure for the uplink transmission occasions allocated for transmission of the one or more RACH preambles based on a lack of corresponding uplink transmission occasions for the one or more PUSCHs.

Some examples of the method, UEs, and non-transitory computer-readable medium described herein may further include operations, features, means, or instructions for receiving an indication to increase a quantity of the uplink transmission occasions allocated for transmission of the one or more RACH preambles, the one or more PUSCHs, or both, via the one or more second messages, a system information message, or both.

In some examples of the method, UEs, and non-transitory computer-readable medium described herein, transmitting the one or more uplink messages may include operations, features, means, or instructions for transmitting the one or more uplink messages via an uplink transmission occasion of the uplink transmission occasions indicated by the set of parameters, where the uplink transmission occasion may be based on increasing the quantity of the uplink transmission occasions, maintaining the quantity of demodulation reference signal (DMRS) sequences, or both.

In some examples of the method, UEs, and non-transitory computer-readable medium described herein, transmitting the one or more uplink messages may include operations, features, means, or instructions for transmitting the one or more uplink messages via an uplink transmission occasion of the uplink transmission occasions indicated by the set of parameters, where the uplink transmission occasion may be based on decreasing the quantity of the uplink transmission occasions.

In some examples of the method, UEs, and non-transitory computer-readable medium described herein, the decrease in the quantity of the uplink transmission occasions allocated for transmission of the one or more RACH preambles includes an exclusion of a slot allocated for the transmission of a RACH or an exclusion of one or more of the uplink transmission occasions allocated for transmission of the one or more RACH preambles.

In some examples of the method, UEs, and non-transitory computer-readable medium described herein, the decrease in the quantity of the uplink transmission occasions allocated for transmission of the one or more RACH preambles corresponds to a decrease or maintenance of the uplink transmission occasions allocated for transmission of the one or more PUSCHs that correspond to the one or more RACH preambles.

In some examples of the method, UEs, and non-transitory computer-readable medium described herein, transmitting the one or more uplink messages may include operations, features, means, or instructions for transmitting the one or more uplink messages via an uplink transmission occasion of the uplink transmission occasions indicated by the set of parameters, where the uplink transmission occasion may be based on increasing the quantity of the uplink transmission occasions.

In some examples of the method, UEs, and non-transitory computer-readable medium described herein, the modification of the at least one parameter includes a decrease in a quantity of the uplink transmission occasions allocated for transmission of the one or more PUSCHs based on a maintained quantity of resource units available per uplink transmission occasion.

In some examples of the method, UEs, and non-transitory computer-readable medium described herein, the modification of the at least one parameter includes a decrease in a quantity of the uplink transmission occasions allocated for transmission of the one or more PUSCHs based on a corresponding increase in a quantity of resource units available per uplink transmission occasion and the corresponding increase in the quantity of resource units may be associated with an increased quantity of DMRS sequences, DMRS ports, or both, allocated for each uplink transmission occasion.

In some examples of the method, UEs, and non-transitory computer-readable medium described herein, the modification of the at least one parameter includes an increase in a quantity of the uplink transmission occasions allocated for transmission of the one or more PUSCHs and the method, apparatuses, and non-transitory computer-readable medium may include further operations, features, means, or instructions for mapping one or more previously unmapped PUSCHs to at least one uplink transmission occasion in accordance with the increase in the quantity of the uplink transmission occasions.

In some examples of the method, UEs, and non-transitory computer-readable medium described herein, the modification of the at least one parameter includes a concurrent increase in a quantity of the uplink transmission occasions allocated for transmission of the one or more RACH preambles and a quantity of the uplink transmission occasions allocated for transmission of the one or more PUSCHs in accordance with the modification of the at least one parameter.

In some examples of the method, UEs, and non-transitory computer-readable medium described herein, the random access configuration includes a first random access configuration of a set of multiple random access configurations associated with respective features of the UE and the method, apparatuses, and non-transitory computer-readable medium may include further operations, features, means, or instructions for receiving a bitmap that indicates a selected random access configuration of the set of multiple random access configurations to which a modification of the set of parameters may be applicable.

In some examples of the method, UEs, and non-transitory computer-readable medium described herein, a first bitmap value indicates that the modification of the set of parameters may be applicable to the first random access configuration associated with a first UE feature.

A method for wireless communications by a network entity is described. The method may include outputting one or more first messages indicative of a set of parameters of a random access configuration for a two-step random access procedure for a UE, the set of parameters indicating uplink transmission occasions of the two-step random access procedure that are available for uplink transmission of one or more RACH preambles, one or more PUSCHs, or both, outputting one or more second messages that modify at least one parameter of the set of parameters of the random access configuration, where modification of the at least one parameter modifies a configuration of the uplink transmission occasions allocated for transmission of the one or more RACH preambles, the one or more PUSCHs, or both of the two-step random access procedure, and obtaining one or more uplink messages in accordance with the modification of the at least one parameter based on the one or more second messages.

A network entity for wireless communications is described. The network entity may include one or more memories storing processor executable code, and one or more processors coupled with the one or more memories. The one or more processors may individually or collectively be operable to execute the code to cause the network entity to output one or more first messages indicative of a set of parameters of a random access configuration for a two-step random access procedure for a UE, the set of parameters indicating uplink transmission occasions of the two-step random access procedure that are available for uplink transmission of one or more RACH preambles, one or more PUSCHs, or both, output one or more second messages that modify at least one parameter of the set of parameters of the random access configuration, where modification of the at least one parameter modifies a configuration of the uplink transmission occasions allocated for transmission of the one or more RACH preambles, the one or more PUSCHs, or both of the two-step random access procedure, and obtain one or more uplink messages in accordance with the modification of the at least one parameter based on the one or more second messages.

Another network entity for wireless communications is described. The network entity may include means for outputting one or more first messages indicative of a set of parameters of a random access configuration for a two-step random access procedure for a UE, the set of parameters indicating uplink transmission occasions of the two-step random access procedure that are available for uplink transmission of one or more RACH preambles, one or more PUSCHs, or both, means for outputting one or more second messages that modify at least one parameter of the set of parameters of the random access configuration, where modification of the at least one parameter modifies a configuration of the uplink transmission occasions allocated for transmission of the one or more RACH preambles, the one or more PUSCHs, or both of the two-step random access procedure, and means for obtaining one or more uplink messages in accordance with the modification of the at least one parameter based on the one or more second messages.

A non-transitory computer-readable medium storing code for wireless communications is described. The code may include instructions executable by one or more processors to output one or more first messages indicative of a set of parameters of a random access configuration for a two-step random access procedure for a UE, the set of parameters indicating uplink transmission occasions of the two-step random access procedure that are available for uplink transmission of one or more RACH preambles, one or more PUSCHs, or both, output one or more second messages that modify at least one parameter of the set of parameters of the random access configuration, where modification of the at least one parameter modifies a configuration of the uplink transmission occasions allocated for transmission of the one or more RACH preambles, the one or more PUSCHs, or both of the two-step random access procedure, and obtain one or more uplink messages in accordance with the modification of the at least one parameter based on the one or more second messages.

Some examples of the method, network entities, and non-transitory computer-readable medium described herein may further include operations, features, means, or instructions for outputting one or more third messages that activate the modification of the at least one parameter, where the one or more first messages include one or more semi-static configuration messages, one or more RRC messages, or both.

In some examples of the method, network entities, and non-transitory computer-readable medium described herein, the modification of the at least one parameter may include operations, features, means, or instructions for increasing or decreasing a quantity of the uplink transmission occasions allocated for transmission of the one or more RACH preambles, the one or more PUSCHs, or both of the two-step random access procedure.

In some examples of the method, network entities, and non-transitory computer-readable medium described herein, the modification of the at least one parameter includes a modification to a RACH configuration index, a modification to a RACH periodicity, an increase or decrease in a quantity of RACH occasions in a subframe, or any combination thereof.

In some examples of the method, network entities, and non-transitory computer-readable medium described herein, the modification of the at least one parameter includes a modification to a per-slot quantity of paging occasions for one or more PUSCH preambles, a modification to a quantity of slots allocated for transmission of one or more PUSCH preambles, a modification to one or more guard periods associated with transmission of one or more PUSCH preambles, a modification to a time domain offset for transmission of one or more PUSCH preambles, a start symbol and length for transmission of one or more PUSCH preambles, or any combination thereof.

In some examples of the method, network entities, and non-transitory computer-readable medium described herein, outputting the one or more second messages that modify the at least one parameter may include operations, features, means, or instructions for outputting the one or more second messages via one or more paging early indications, one or more DCI messages, one or more paging payload messages, or any combination thereof.

In some examples of the method, network entities, and non-transitory computer-readable medium described herein, the modification of the at least one parameter occurs in accordance with a modification periodicity that changes a quantity of the uplink transmission occasions allocated for transmission of the one or more RACH preambles, the one or more PUSCHs, or both, during modification intervals of the modification periodicity.

In some examples of the method, network entities, and non-transitory computer-readable medium described herein, the modification of the at least one parameter may include operations, features, means, or instructions for increasing a quantity of the uplink transmission occasions allocated for transmission of the one or more RACH preambles and increasing a corresponding quantity of uplink transmission occasions for the one or more PUSCHs associated with the one or more RACH preambles in accordance with the set of parameters of the random access configuration.

In some examples of the method, network entities, and non-transitory computer-readable medium described herein, the modification of the at least one parameter may include operations, features, means, or instructions for increasing a quantity of the uplink transmission occasions allocated for transmission of the one or more RACH preambles and outputting a system information message that indicates a configuration for a corresponding quantity of uplink transmission occasions for the one or more PUSCHs associated with the one or more RACH preambles.

Some examples of the method, network entities, and non-transitory computer-readable medium described herein may further include operations, features, means, or instructions for outputting an indication to increase a quantity of the uplink transmission occasions allocated for transmission of the one or more RACH preambles, the one or more PUSCHs, or both, via the one or more second messages, a system information message, or both.

In some examples of the method, network entities, and non-transitory computer-readable medium described herein, modification of the at least one parameter increases a quantity of the uplink transmission occasions allocated for transmission of the one or more RACH preambles and for the one or more PUSCHs and the modification of the at least one parameter maintains or modifies a quantity of DMRS sequences associated with transmission of the one or more PUSCHs.

In some examples of the method, network entities, and non-transitory computer-readable medium described herein, the modification of the at least one parameter may include operations, features, means, or instructions for decreasing a quantity of the uplink transmission occasions allocated for transmission of the one or more RACH preambles based on a modification to an uplink transmission occasion periodicity, a configuration index modification, a muting pattern modification, or any combination thereof.

In some examples of the method, network entities, and non-transitory computer-readable medium described herein, decreasing the quantity of the uplink transmission occasions allocated for transmission of the one or more RACH preambles may include operations, features, means, or instructions for removing a slot allocated for the transmission of a RACH or removing one or more of the uplink transmission occasions allocated for transmission of the one or more RACH preambles.

In some examples of the method, network entities, and non-transitory computer-readable medium described herein, decreasing the quantity of the uplink transmission occasions allocated for transmission of the one or more RACH preambles may include operations, features, means, or instructions for decreasing or maintaining the uplink transmission occasions allocated for transmission of the one or more PUSCHs that correspond to the one or more RACH preambles based on decreasing the quantity of the uplink transmission occasions allocated for transmission of the one or more RACH preambles.

In some examples of the method, network entities, and non-transitory computer-readable medium described herein, the modification of the at least one parameter may include operations, features, means, or instructions for increasing a quantity of the uplink transmission occasions allocated for transmission of the one or more PUSCHs based on a corresponding increase in a quantity of DMRS sequences, DMRS ports, a per-slot quantity of uplink shared channel transmission occasions, a total quantity of uplink shared channel transmission occasions, or any combination thereof.

In some examples of the method, network entities, and non-transitory computer-readable medium described herein, the modification of the at least one parameter may include operations, features, means, or instructions for decreasing a quantity of the uplink transmission occasions allocated for transmission of the one or more PUSCHs based on a maintained quantity of resource units available per uplink transmission occasion.

In some examples of the method, network entities, and non-transitory computer-readable medium described herein, the modification of the at least one parameter may include operations, features, means, or instructions for decreasing a quantity of the uplink transmission occasions allocated for transmission of the one or more PUSCHs based on a corresponding increase in a quantity of resource units available per uplink transmission occasion, where the corresponding increase in the quantity of resource units may be associated with an increased quantity of DMRS sequences, DMRS ports, or both, allocated for each uplink transmission occasion.

In some examples of the method, network entities, and non-transitory computer-readable medium described herein, the random access configuration includes a first random access configuration of a set of multiple random access configurations associated with respective features of the UE and the method, apparatuses, and non-transitory computer-readable medium may include further operations, features, means, or instructions for outputting a bitmap that indicates a selected random access configuration of the set of multiple random access configurations to which a modification of the set of parameters may be applicable.

In some examples of the method, network entities, and non-transitory computer-readable medium described herein, a first bitmap value indicates that the modification of the set of parameters may be applicable to the first random access configuration associated with a first UE feature.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 shows examples of wireless communications systems that

support adaptation of random access channel (RACH) procedures in accordance with one or more aspects of the present disclosure.

FIGS. 3, 4, and 5 show examples of RACH transmission configurations that support adaptation of RACH procedures in accordance with one or more aspects of the present disclosure.

FIG. 6 shows an example of a process flow that supports adaptation of RACH procedures in accordance with one or more aspects of the present disclosure.

FIGS. 7 and 8 show block diagrams of devices that support adaptation of RACH procedures in accordance with one or more aspects of the present disclosure.

FIG. 9 shows a block diagram of a communications manager that supports adaptation of RACH procedures in accordance with one or more aspects of the present disclosure.

FIG. 10 shows a diagram of a system including a device that supports adaptation of RACH procedures in accordance with one or more aspects of the present disclosure.

FIGS. 11 and 12 show block diagrams of devices that support adaptation of RACH procedures in accordance with one or more aspects of the present disclosure.

FIG. 13 shows a block diagram of a communications manager that supports adaptation of RACH procedures in accordance with one or more aspects of the present disclosure.

FIG. 14 shows a diagram of a system including a device that supports adaptation of RACH procedures in accordance with one or more aspects of the present disclosure.

FIGS. 15 and 16 show flowcharts illustrating methods that support adaptation of RACH procedures in accordance with one or more aspects of the present disclosure.

### DETAILED DESCRIPTION

A user equipment (UE) may participate in a random access channel (RACH) procedure to obtain initial timing and frequency synchronization with a network entity, and to obtain system information for ongoing communications. In some cases, the UE may perform a multi-step RACH procedure (such as a 4-step RACH procedure or a 2-step RACH procedure), in which the UE communicates various messages with the network entity. In a 4-step RACH procedure, for example, the UE may transmit a contention-based physical random access channel (PRACH) preamble (e.g., Msg1), and the network entity may respond with a random-access response (RAR) message (e.g., Msg2). The UE may then transmit a scheduled physical uplink shared channel (PUSCH) (e.g., Msg3) in response to the RAR, to which the network entity responds with a contention resolution message (e.g., Msg4).

By contrast, in a 2-step RACH procedure may allow for a single round trip cycle between the UE and the network entity by combining the preamble (Msg1) and the scheduled PUSCH transmission (Msg3) into a single message (MsgA) from the UE to the network entity, and combining the random-access respond (Msg2) and the contention resolution message (Msg4) into a single message (MsgB) from the network entity to UE. In some aspects, the 2-step RACH procedure may reduce the latency and control signaling overhead related to 4-step RACH procedure.

The reduction in control signaling overhead associated with the 2-step RACH procedure may also be associated with increased network-side energy savings and UE-side energy savings. To further increase power saving gains, the 2-step RACH procedure may be modified or adapted to increase or decrease the periodicity of RACH occasions or PUSCH occasions associated with the 2-step RACH procedure. In some cases, however, such modifications may pose challenges. For example, the first message (e.g., MsgA) may include a combination of both RACH occasions and PUSCH occasions, where 4-step RACH has either RACH occasions or PUSCH occasions per message. The combination of both RACH occasions and PUSCH occasions, among other factors, may increase the complexity of adapting the 2-step RACH procedure.

In order to efficiently adapt the 2-step RACH procedure, the UE may receive a 2-step RACH adaptation, which instructs the UE to adapt the 2-step RACH configuration by increasing or decreasing the quantity of RACH occasions, PUSCH occasions, or both. For example, the UE may receive signaling which includes the 2-step RACH adaptation, such as signaling that indicates a change in one or more of the RACH preamble configuration, the MsgA PUSCH configuration, or both. In some examples, the signaling may include changes to one or more RACH parameters including, but not limited to, a PRACH configuration index, a PRACH periodicity, a quantity of RACH occasions in a sub-frame, among other RACH parameters or a combination of RACH parameters.

In some aspects, the UE may be configured with an initial 2-step RACH configuration (e.g., a baseline 2-step RACH configuration), and then may receive a modification to the configuration, which dynamically adapts the 2-step RACH configuration to increase or decrease the quantity of RACH occasions, PUSCH occasions, or both. In some examples, the UE may receive the modification to the configuration of the 2-step RACH procedure, and then may receive additional signaling (such as a trigger signal or other control message) that activates the modification.

Aspects of the disclosure may be implemented to realize one or more advantages. For example, the adaptation of the 2-step RACH procedure may allow for more efficient and coordinated usage of 2-step RACH by dynamically increasing or decreasing a quantity or timing and frequency allocation for RACH occasions, PUSCH occasions, or both. In some aspects, different adaptations of the 2-step RACH procedure may allow for reduced signaling overhead and increased power savings for both the network entity and for the UE. Additionally, or alternatively, the adaptation of the 2-step RACH procedure may allow for more flexible configuration of RACH from the network perspective, and more effective initial synchronization with the network from the UE perspective.

Aspects of the disclosure are initially described in the context of wireless communications systems. Aspects of the disclosure are further illustrated by and described with reference to RACH transmission configurations, a process flow, apparatus diagrams, system diagrams, and flowcharts that relate to adaptation of RACH procedures.

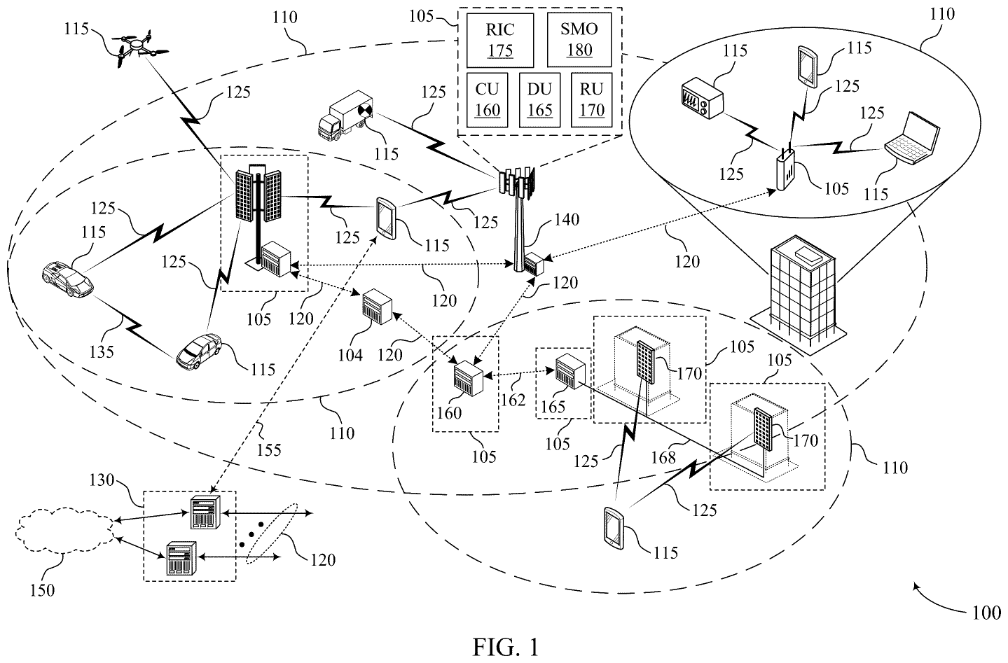

FIG. 1 shows an example of a wireless communications system 100 that supports adaptation of RACH procedures in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A UE 115 may support RACH procedures in order to obtain an initial synchronization with a network entity 105. In some examples, the UE 115 may transmit preamble transmissions via one or more RACH occasions, PUSCH occasions, or both. A PUSCH occasion for PUSCH transmission may be defined by a frequency resource and a time resource, and is associated with a DMRS resource. The DMRS resources are provided by a DMRS configuration message (e.g., msgA-DMRS-Config). Each consecutive number of N_{preamble} preamble indexes from valid PRACH occasions in a PRACH slot may be incremented in increasing order of preamble indexes within a single PRACH occasion, in increasing order of frequency resource indexes for frequency multiplexed PRACH occasions, in increasing order of time resource indexes for time multiplexed PRACH occasions within a PRACH slot. In some aspects, preamble indices may be mapped to a valid PUSCH occasion and the associated DMRS resource in increasing order of frequency resource indexes (e.g., f_{id}) for frequency multiplexed PUSCH occasions, in increasing order of DMRS resource indexes within a PUSCH occasion, where a DMRS resource index (e.g., DMRS_{id}) may be determined first in an ascending order of a DMRS port index and second in an ascending order of a DMRS sequence index, in increasing order of time resource indexes (e.g., t_{id}) for time multiplexed PUSCH occasions within a PUSCH slot, and in increasing order of indexes for Nₛ PUSCH slots.

In some aspects, PUSCH occasions may be defined by various parameters, including a number of MsgA PUSCH occasions per slot (e.g., nrOfMsgA-PO-perSlot), a number of PUSCH slots for transmission of MsgA (e.g., nrofSlotsMsgA-PUSCH), a guard period parameter (e.g., guardPeriodMsgA-PUSCH), a time domain offset parameter (e.g., msgA-PUSCH-TimeDomainOffset), a starting symbol and length parameter associated with PUSCH occasions (e.g., startSymbolAndLengthMsgA-PO), a MsgA mapping type parameter (e.g., mappingTypeMsgA-PUSCH-r16), and a configuration index parameter (e.g., msgA-PRACH-ConfigurationIndex-r16).

A UE 115 may participate in a RACH procedure (such as a 4-step RACH procedure or a 2-step RACH procedure) to obtain initial timing and frequency synchronization with a network entity 105. In a 4-step RACH procedure, for example, the UE 115 may transmit a contention-based PRACH preamble (e.g., Msg1), and the network entity 105 may respond with a RAR message (e.g., Msg2). The UE 115 may then transmit a scheduled PUSCH (e.g., Msg3) in response to the RAR, to which the network entity 105 responds with a contention resolution message (e.g., Msg4). In a 2-step RACH procedure, the preamble (Msg1) and the scheduled PUSCH transmission (Msg3) may be combined into a single message (MsgA) from the UE 115 to the network entity 105, and the random-access respond (Msg2) and the contention resolution message (Msg4) may be combined into a single message (MsgB) from the network entity 105 to UE 115.

The reduction in control signaling overhead associated with the 2-step RACH procedure may be associated with reduced signaling overhead and increased network-side energy savings and UE-side energy savings. To further increase power saving gains, the 2-step RACH procedure may be modified or adapted to increase or decrease the periodicity of RACH occasions or PUSCH occasions associated with the 2-step RACH procedure. In some cases, however, such modifications may pose challenges. For example, the first message (e.g., MsgA) may include a combination of both RACH occasions and PUSCH occasions, where 4-step RACH has either RACH occasions or PUSCH occasions per message. The combination of both RACH occasions and PUSCH occasions, among other factors, may increase the complexity of adapting the 2-step RACH procedure.

In order to efficiently adapt the 2-step RACH procedure, the UE 115 may receive a 2-step RACH adaptation, which instructs the UE 115 to adapt the 2-step RACH configuration by increasing or decreasing the quantity of RACH occasions, PUSCH occasions, or both. For example, the UE 115 may receive signaling which includes the 2-step RACH adaptation, such as signaling that indicates a change in one or more of the RACH preamble configuration, the MsgA PUSCH configuration, or both. In some examples, the signaling may include changes to one or more RACH parameters including, but not limited to, a PRACH configuration index, a PRACH periodicity, a quantity of RACH occasions in a sub-frame, among other RACH parameters or a combination of RACH parameters.

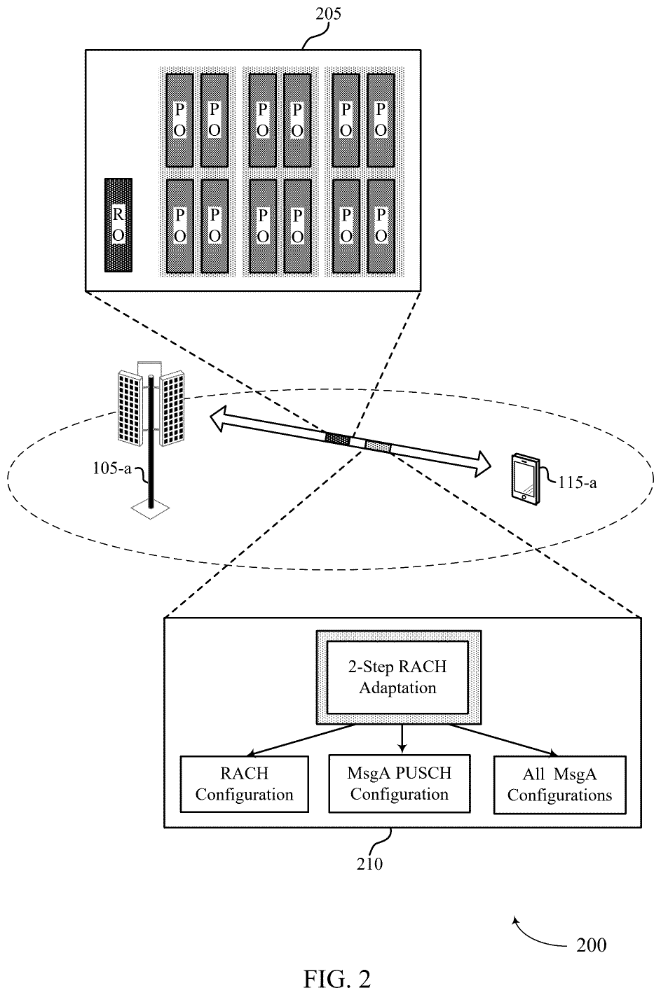

FIG. 2 shows an example of a wireless communications system 200 that supports adaptation of RACH procedures in accordance with one or more aspects of the present disclosure. For example, the wireless communications system illustrates communications between a UE 115-a and a network entity 105-a, each of which may be examples of corresponding UEs 115 and network entities 105 described with reference to FIG. 1.

Upon powering on (or otherwise transitioning from an inactive to active mode), the UE 115-a may participate in a RACH procedure in order to perform timing and frequency synchronization with the network entity 105-a, and to obtain system information for ongoing communications. In some implementations, the UE 115-a may perform a multi-step RACH procedure (such as a 4-step RACH procedure or a 2-step RACH procedure), in which the UE 115-a communicates various messages with the network entity 105-a. For example, in a 4-step RACH procedure, the UE 115-a may transmit a contention-based PRACH preamble (e.g., Msg1), and the network entity 105-a may respond with a RAR message (e.g., Msg2). The UE 115-a may then transmit a scheduled PUSCH (e.g., Msg3) in response to the RAR, to which the network entity 105-a responds with a contention resolution message (e.g., Msg4).

In some other examples, the UE 115-a may perform a 2-step RACH procedure to reduce the latency and control signaling overhead related to 4-step RACH procedures, and to reduce the relative quantity of listen-before-talk (LBT) attempts of the UE 115-a. For example, the 2-step RACH procedure may allow for a single round trip cycle between the UE 115-a and the network entity 105-a by combining the preamble (Msg1) and the scheduled PUSCH transmission (Msg3) into a single message (MsgA) from the UE 115-a to the network entity 105-a (e.g., the first message 205), and combining the random-access respond (Msg2) and the contention resolution message (Msg4) into a single message (MsgB) from the network entity 105-a to UE 115-a.

The reduction in control signaling overhead associated with the 2-step RACH procedure may also be associated with increased network-side energy savings and UE-side energy savings. To further increase power saving gains, the UE 115-a, the network entity 105-a, or both, may adapt the 2-step RACH procedure by modifying (e.g., increasing or decreasing) the periodicity of RACH occasions or PUSCH occasions associated with the 2-step RACH. In some cases, however, such modifications may pose challenges. For example, the first message 205 that the UE 115-a sends to the network entity 105-b (e.g., MsgA) includes a combination of both RACH occasions (e.g., “ROs”) and PUSCH occasions (e.g., “POs”), where 4-step RACH has either RACH occasions or PUSCH occasions per message. The combination of both RACH occasions and PUSCH occasions, among other factors, may increase the complexity of adapting the 2-step RACH procedure.

A RACH occasion may include time and frequency resources allocated for the MsgA RACH preamble transmission. In some aspects, multiple 2-step RACH capable UEs can share or utilize the time and frequency resources of a same RACH occasion in transmitting respective preambles. For example, the UEs may select different RACH preamble sequences and may perform code domain multiplexing in order to avoid preamble collision. A PUSCH occasion may include time and frequency resources allocated for MsgA PUSCH transmission. In some implementations, a guard band, a guard time, or both, may be configured for each PUSCH transmission to mitigate inter-symbol interference and inter-carrier interference, and to support asynchronous uplink transmission in 2-step RACH. In some examples, the PUSCH transmission may be associated with a PUSCH occasion and a corresponding DMRS port and/or DMRS sequence which may be referred to as a PUSCH resource unit (PRU) used for MsgA payload transmission.

In some aspects, the contents of the MsgA payload and the size of the MsgA payload may be based on various use cases and link qualities. For example, the content and size of the MsgA payload may be based on the UE 115-a operating in an RRC idle or RRC inactive state, in which the MsgA payload may include a unique UE identifier associated with the UE 115-a, one or more RRC requests, data, or any combination thereof. Additionally, or alternatively, when the UE is operating in an RRC connected state, the content of the MsgA payload may include one or more medium access control-control elements (MAC-CEs), data from a user plane or a control plane, or any combination thereof. In some aspects, the UE 115-a may utilize multiple different PUSCH occasion formats to accommodate different use cases and coverage requirements, and based on different traffic patterns or network load.

In some implementations, in order to adapt the 2-step RACH procedure, The UE 115-a may receive a 2-step RACH adaptation 210, which instructs the UE 115-a to adapt the 2-step RACH configuration by effectively increasing or decreasing the quantity of RACH occasions, PUSCH occasions, or both. For example, the UE 115-a may receive signaling which includes the 2-step RACH adaptation 210, such as signaling that indicates a change in one or more of the RACH preamble configuration, the MsgA PUSCH configuration, or both. In some examples, the signaling may include changes to one or more RACH parameters including, but not limited to, a PRACH configuration index, a PRACH periodicity, a quantity of RACH occasions in a sub-frame, among other RACH parameters or a combination of RACH parameters.

Additionally, or alternatively, the signaling may include changes to one or more PUSCH occasion parameters including, but not limited to, a parameter that indicates a quantity of MsgA PUSCH occasions configured per slot (e.g., nrOfMsgA-PO-perSlot), a parameter that indicates a quantity of slots configured for transmission of MsgA (e.g., nrofSlotsMsgA-PUSCH), a guard period parameter (e.g., guardPeriodMsgA-PUSCH), a time domain offset parameter (e.g., msgA-PUSCH-TimeDomainOffset), a PUSCH occasion start symbol and length (SLIV) parameter (e.g., startSymbolAndLengthMsgA-PO), a PUSCH mapping type parameter (e.g., mappingTypeMsgA-PUSCH-r16), a configuration index parameter (e.g., msgA-PRACH-ConfigurationIndex-r16), among other PUSCH occasion parameters. In some implementations, the 2-step RACH adaptation 210 may be signaled in various different messages, including, for example, a paging early indication (PEI), a paging downlink control information (DCI) message, a paging payload message, any other DCI type, or via one or more configured adaptation messages transmitted in accordance with a periodicity.

In some aspects, the UE 115-a may be configured with an initial 2-step RACH configuration (e.g., a baseline 2-step RACH configuration), and then may receive a modification to the configuration, which dynamically adapts the 2-step RACH configuration to increase or decrease the quantity of RACH occasions, PUSCH occasions, or both. For example, the modification to the configuration may be conveyed as change in a preamble configuration or a MsgA PUSCH configuration, and may include changes to different RACH parameters such as RACH configuration index, PRACH periodicity, a quantity of RACH occasions per sub-frame, other PUSCH occasion parameter modifications, among other adaptations. In some examples, the UE 115-a may receive the modification to the configuration of the 2-step RACH procedure, and then may receive additional signaling (such as a trigger signal or other control message) that activates the modification.

In some implementations, the network entity 105-a may transmit, to the UE 115-a, one or more additional MsgA configurations (e.g., msgA-Config-Common configurations), in addition to or instead of a baseline MsgA configuration. In some aspects, the different MsgA configurations may be associated with different UE features. In some such implementations, if the network entity 105-a indicates multiple different MsgA configurations for the different UE features (e.g., whether the UE is a reduced capability (RedCap) UE, whether the UE has small data transmission (SDT) capabilities, whether the UE supports Msg3 repetition, whether the UE supports network slicing, among other features) the network entity 105-a may also indicate a specific UE set for which an adapted RACH configuration (e.g., an adapted MsgA-Config-Common) is applicable. For example, the network entity 105-a may transmit or indicate a bitmap (e.g., a 5-bit bitmap) that indicates a specific UE feature for which the adapted RACH configuration is applicable. In some cases, the mapping between a signaled bit and a UE feature may depend on an actual quantity of conveyed RACH configurations (e.g., MsgA-Config-Common configurations).

In cases that the network entity 105-a uses a bitmap indication, the network entity 105-a may configure a quantity of available RACH configurations, for example, five MsgA-Config-Common configurations (e.g., one configuration for each of baseline UE features or capabilities, RedCap features or capabilities, SDT features or capabilities, Msg3 repetition features or capabilities, network slicing features or capabilities). In such examples, a bitmap having a value of 00000 may indicate that the adapted MsgA-Config-Common configuration may be applicable for UEs that support baseline features, a bitmap value of 00001 indicates that the adapted MsgA-Config-Common configuration may be applicable for UEs that support RedCap, a bitmap value of 00010 indicates that the adapted MsgA-Config-Common configuration may be applicable for UEs that support SDT capabilities, a bitmap value of 00011 indicates that the adapted MsgA-Config-Common configuration may be applicable for UEs that support Msg3 repetition, and a bitmap value of 00100 indicates that the adapted MsgA-Config-Common configuration may be applicable for UEs that support network slicing. The 5-bit bitmap and features described herein may be examples, and other possible quantities of bitmap bits and features may be utilized.

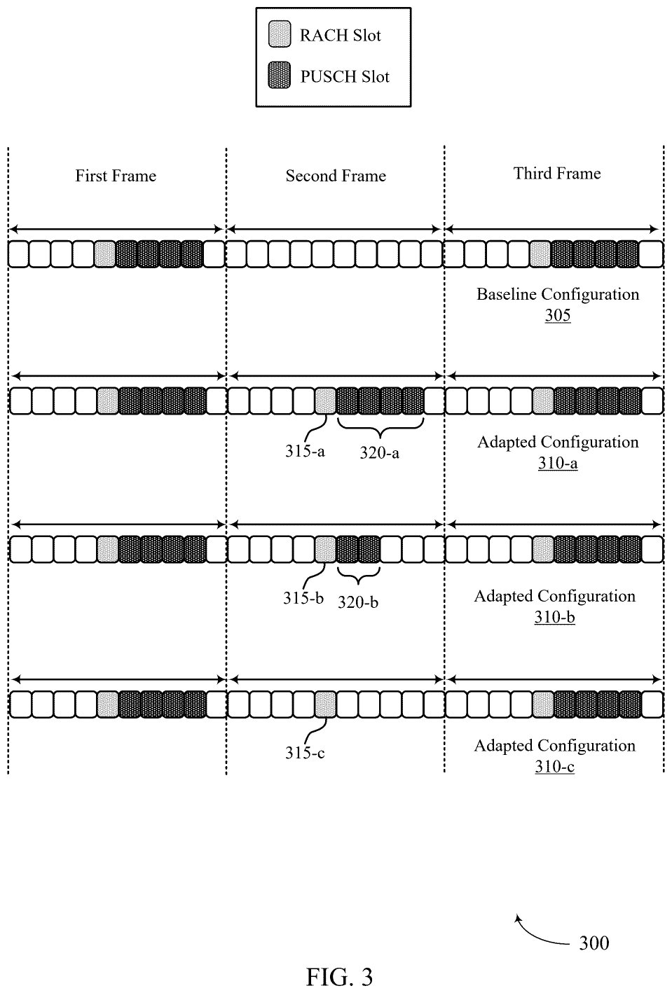

FIG. 3 shows example RACH transmission configurations 300 that support adaptation of RACH procedures in accordance with one or more aspects of the present disclosure. For example, the RACH transmission configurations 300 may be implemented at or by a UE that is capable of performing a 2-step RACH procedure, such as UEs 115 described herein, including with reference to FIGS. 1 and 2.

In some implementations, a UE may operate in accordance with a baseline 2-step RACH configuration, for example, in accordance with the baseline configuration 305. In such examples, the UE may be configured with a first quantity of RACH occasions and a corresponding first quantity of PUSCH occasions in a first frame, an absence of RACH occasions and PUSCH occasions in a second frame, and the first quantity of RACH occasions and the corresponding first quantity of PUSCH occasions again in the third frame.

In some examples, the UE may receive an indication of an adapted RACH configuration 310-a. The adapted RACH configuration 310-a may include the RACH occasions and PUSCH occasions of the baseline configuration 305, with additional RACH slots (e.g., RACH slot 315-a) in the second frame. The UE may then identify or consider corresponding PUSCH occasions 320-a associated with the RACH slot in the second frame based on the baseline configuration 305 (e.g., the corresponding PUSCH occasions 320-a may be associated or configured in accordance with the baseline configuration 305).

In some examples, the UE may receive an indication of an adapted RACH configuration 310-b. The adapted RACH configuration 310-b may include the RACH occasions and PUSCH occasions of the baseline configuration 305, with additional RACH slots (e.g., RACH slot 315-b) in the second frame. The UE may then identify a configuration for the corresponding PUSCH occasions 320-b associated with the RACH slot in the second frame. In some aspects, the configuration for the PUSCH occasions 320-b may be a configuration that is associated with the addition of RACH slot 315-b, and may be separate from the baseline configuration 305. In some examples, the UE may receive an indication of the configuration for the PUSCH occasions 320-b via system information signaling, such as via SIBI information signaling.

In some examples, the UE may receive an indication of an adapted RACH configuration 310-c. The adapted RACH configuration 310-c may include the RACH occasions and PUSCH occasions of the baseline configuration 305, with additional RACH slots (e.g., RACH slot 315-c) in the second frame. In some such examples, the additional RACH slots may be added to the adapted RACH configuration 310-c without additional PUSCH occasions. In some aspects, the addition of additional RACH slots without associated PUSCH occasions may be implemented in 2-step RACH and 4-step RACH procedures.

In some implementations, the UE may receive an indication regarding which RACH configuration to follow (e.g., the baseline configuration 305, the adapted RACH configuration 310-a, the adapted RACH configuration 310-b, or the adapted RACH configuration 310-c) via system information signaling (e.g., SIB1 signaling) or via a separate indication (e.g., the RACH adaptation indication that includes the configuration for the RACH adaptation).

In some examples, adding additional RACH occasions may be achieved by increasing the quantity of RACH occasions per RACH slot. In some such examples, the corresponding quantity of PUSCH occasions may remain the same, but the quantity of transmissions in a PUSCH occasion may similarly increase. In some implementations, for example, the UE may receive a dynamic indication (e.g., via control signaling or system information signaling) that increases the quantity of RACH occasions per slot. In response, to increase the quantity of PUSCH occasions per slot correspondingly, the UE may utilize additional DMRS sequences, DMRS ports, or both, for PUSCH occasions that correspond to the increased quantity or RACH occasions. In some other examples, the UE may utilize additional PUSCH occasions, but may experience no change in additional DMRS sequences, DMRS ports, or both. In some other examples, the UE may assume that an additional quantity of PUSCH occasions are added or dedicated for the increased quantity of RACH occasions.

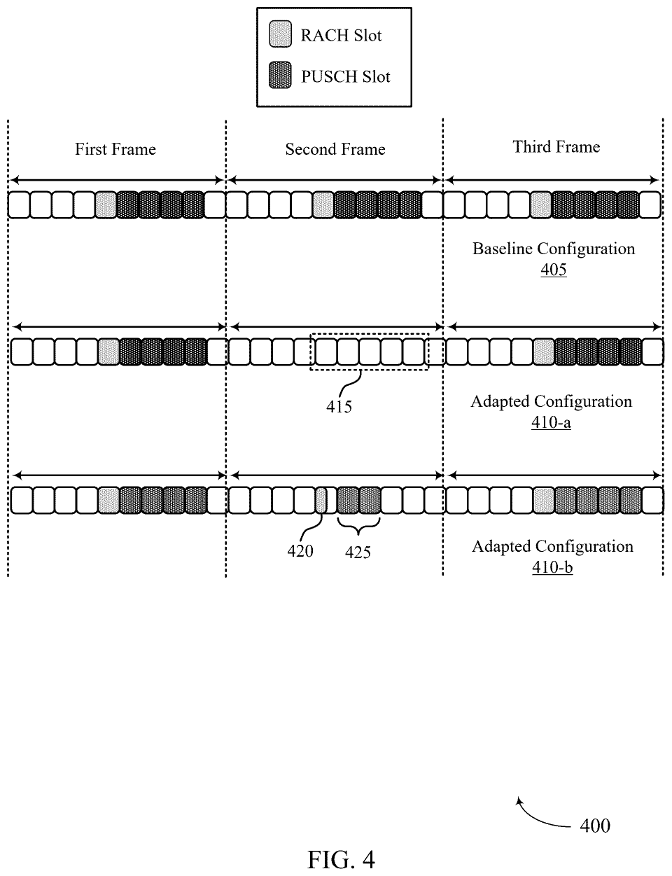

FIG. 4 shows examples of RACH transmission configurations 400 that

support adaptation of RACH procedures in accordance with one or more aspects of the present disclosure. For example, the RACH transmission configurations 400 may be implemented at or by a UE that is capable of performing a 2-step RACH procedure, such as UEs 115 described herein, including with reference to FIGS. 1 and 2.

In some implementations, a UE may operate in accordance with a baseline 2-step RACH configuration, for example, in accordance with the baseline configuration 405. In such examples, the UE may be configured with a first quantity of RACH occasions and a corresponding first quantity of PUSCH occasions in a first frame, a second frame, and a third frame. In some examples, the UE may receive an indication of an adapted RACH configuration, in which one or more RACH occasions are removed relative to the baseline configuration 405. For example, the one or more RACH occasions may be removed based on a periodicity, configuration index, a muting pattern for the one or more RACH occasions, or any combination thereof.

In some examples, the UE may receive an indication of an adapted RACH configuration 410-a, in which an entire RACH slot is removed (e.g., muted, such as in accordance with a muting pattern) along with corresponding PUSCH occasions (e.g., at slots 415) relative to the baseline configuration. The adapted RACH configuration 410-a may include the RACH occasions and PUSCH occasions of the baseline configuration 405, without the RACH occasions and PUSCH occasions of the second frame.

In some examples, the UE may receive an indication of an adapted RACH configuration 410-b, in which RACH occasions within a RACH slot are removed, but at least a portion of the RACH slot remains (e.g., RACH slot portion 420). In some aspects, the removal of RACH occasions from the RACH slot may impact (or may not impact) the corresponding PUSCH occasions 425. For example, in some cases the reduction of the RACH occasions may reduce the quantity of MsgA PUSCH slots or PUSCH occasions within a slot. In some other examples, the reduction of the RACH occasions may eliminate the PUSCH occasions, with remaining RACH occasions used for a 4-step RACH procedure.

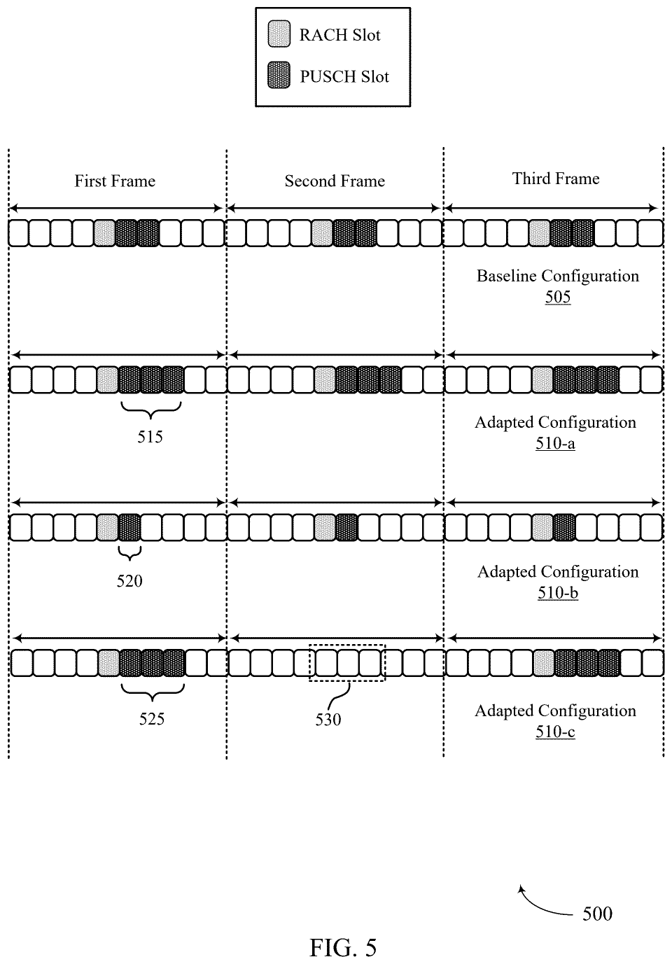

FIG. 5 shows example RACH transmission configurations 500 that support adaptation of RACH procedures in accordance with one or more aspects of the present disclosure. For example, the RACH transmission configurations 500 may be implemented at or by a UE that is capable of performing a 2-step RACH procedure, such as UEs 115 described herein, including with reference to FIGS. 1 and 2.

In some implementations, a UE may operate in accordance with a baseline 2-step RACH configuration, for example, in accordance with the baseline configuration 505. In such examples, the UE may be configured with a first quantity of RACH occasions and a corresponding first quantity of PUSCH occasions in a first frame, a second frame, and a third frame. In some examples, the UE may receive an indication of an adapted RACH configuration, in which one or more RACH occasions, PRUs, PUSCH occasions, or any combination thereof, are removed or added relative to the baseline configuration 505.

In some examples, the UE may receive an indication of an adapted RACH configuration 510-a, in which the quantity of PRUs or PUSCH occasions (e.g., PUSCH occasions 515) are increased in quantity relative the PRUs or PUSCH occasions of the baseline configuration 505. In some aspects, the UE may receive an indication of an increase in DMRS sequences, DMRS ports, PUSCH occasions per slot, or total quantity of PUSCH occasions, which may indicate the increased quantity of PUSCH occasions. In some examples, the addition of new PUSCH occasions may allow for previously unmapped RACH preambles to be mapped to the newly added PRUs (or the unmapped RACH preambles may remain unmapped, in some examples). Additionally, or alternatively, the UE may refrain from transmitting a PUSCH in a PUSCH occasion if the PUSCH occasion associated with a DMRS resource is unmapped to a preamble of one or more valid RACH occasions, and the UE may transmit a RACH preamble in a valid RACH occasion if the RACH preamble is not mapped to a valid PUSCH occasion.

In some examples, the UE may receive an indication of an adapted RACH configuration 510-b, in which the quantity of PRUs or PUSCH occasions (e.g., PUSCH occasion 520) are decreased in quantity relative the PRUs or PUSCH occasions of the baseline configuration 505. In some aspects, the UE may receive an indication of a decrease in DMRS sequences, DMRS ports, PUSCH occasions per slot, or total quantity of PUSCH occasions, which may indicate the decreased quantity of PUSCH occasions. In some cases, reducing the quantity of PUSCH occasions (without a corresponding change to the DMRS sequences, DMRS ports, or both) might reduce the quantity of available RACH preambles, which may increase collisions. In some such examples, to reduce the likelihood of collisions, the same quantity of PRUs may be maintained per PUSCH occasion. In some other examples, the quantity of PRUs per PUSCH occasion may be increased by autonomously adding more DMRS sequences, DMRS ports, or both, in each PUSCH occasion. In such examples, the addition of DMRS sequences, DMRS ports, or both, may be indicated in system information (e.g., SIB1).

In some examples, the UE may receive an indication of an adapted RACH configuration 510-c, in which the adaptation of PRUs or PUSCH occasions and RACH occasions may occur simultaneously. For example, the indication may indicate a change in a RACH parameter and a change in the PUSCH occasions (e.g., the MsgA PUSCH occasions). In some aspects, the simultaneous adaptation of the PRUs or PUSCH occasions and the RACH occasions may allow for an increase or decrease in PRUs or PUSCH occasions along with a corresponding increase or decrease in RACH occasions. In the adapted RACH configuration 510-c, for example, the quantity of PUSCH occasions 525 is increased relative to the baseline configuration 505, while the RACH occasion and corresponding PUSCH occasions are eliminated from slots 530 relative to the baseline configuration 505.

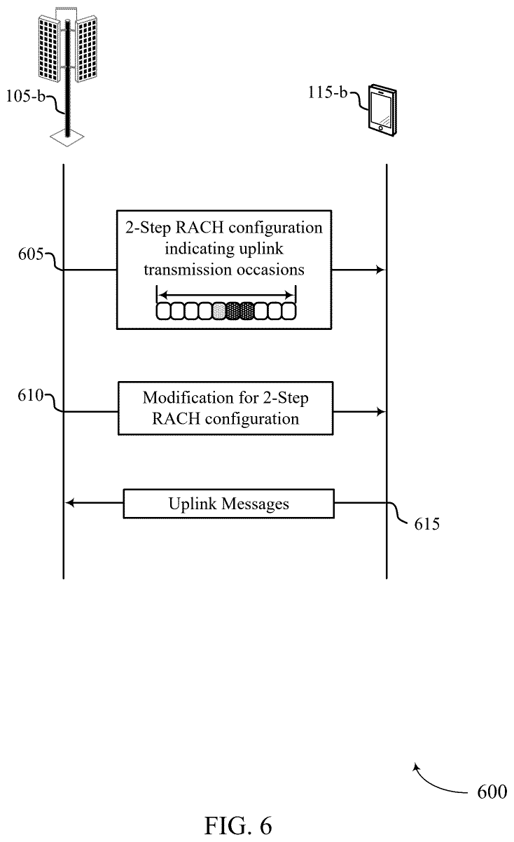

FIG. 6 shows an example of a process flow 600 that supports adaptation of RACH procedures in accordance with one or more aspects of the present disclosure. For example, the process flow 600 illustrates communications between a UE 115-b, which may be an example a UE 115 described herein, and a network entity 105-b, which may be an example of a network entity 105 described herein.

Alternative examples of the following may be implemented. Some steps are performed in a different order than described or are not performed at all. In some implementations, steps may include additional features not mentioned below, or additional steps may be added. Further, although the UE 115-b and the network entity 105-b are shown performing the operations of the process flow 600, some aspects of some operations may also be performed by one or more other wireless communication devices.

At 605, the UE 115-b may receive one or more first messages that indicate a set of parameters of a random access configuration (e.g., a RACH configuration) for a two-step random access procedure for the UE, the set of parameters indicating uplink transmission occasions of the two-step random access procedure that are available for uplink transmission of one or more RACH preambles (e.g., RACH occasions), one or more PUSCHs (e.g., PUSCH occasions), or both.

In some examples, the one or more first messages include a first random access configuration of a set of random access configurations associated with respective features of the UE 115-b, and the UE 115-b may receive a bitmap that indicates a selected random access configuration of the set of random access configurations to which a modification of the set of parameters is applicable. For example, a first bitmap value indicates that the modification of the set of parameters is applicable to the first random access configuration associated with a first UE feature.

At 610, the UE 115-b may receive one or more second messages that modify at least one parameter of the set of parameters of the random access configuration. In some aspects, the modification of the at least one parameter modifies a configuration of the uplink transmission occasions allocated for transmission of the one or more RACH preambles, the one or more PUSCHs, or both of the two-step random access procedure. In some examples, the UE 115-b may receive the one or more second messages via one or more paging early indications, one or more downlink control information messages, one or more paging payload messages, or any combination thereof.

In some examples, the UE 115-b may receive one or more third messages that activate the modification of the at least one parameter received in the one or more second messages. In some aspects, the one or more first messages include or more semi-static configuration messages, one or more radio resource control messages, or both, and the one or more third messages include one or more trigger messages or activation messages.

In some implementations, the modification of the at least one parameter includes an increase or decrease in a quantity of the uplink transmission occasions allocated for transmission of the one or more RACH preambles, the one or more PUSCHs, or both, of the two-step random access procedure. In some implementations, the modification of the at least one parameter includes a modification to a RACH configuration index, a modification to a RACH periodicity, an increase or decrease in a quantity of RACH occasions in a subframe, or any combination thereof. In some implementations, the modification of the at least one parameter includes a modification to a per-slot quantity of paging occasions for one or more PUSCH preambles, a modification to a quantity of slots allocated for transmission of one or more PUSCH preambles, a modification to one or more guard periods associated with transmission of one or more PUSCH preambles, a modification to a time domain offset for transmission of one or more PUSCH preambles, a start symbol and length for transmission of one or more PUSCH preambles, or any combination thereof.

In some examples, the modification of the at least one parameter includes an increase in a quantity of the uplink transmission occasions allocated for transmission of the one or more RACH preambles, and an increase in a corresponding quantity of uplink transmission occasions for the one or more PUSCHs associated with the one or more RACH preambles in accordance with the set of parameters of the random access configuration. In some examples, the modification of the at least one parameter includes an increase in the quantity of uplink transmission occasions allocated for the transmission of the one or more RACH preambles, and the UE 115-b may receive a system information message (e.g., a SIB) that indicates a configuration for a corresponding quantity of uplink transmission occasions for the one or more PUSCHs associated with the one or more RACH preambles. In some examples, the UE 115-b may perform a four-step random access procedure for the uplink transmission occasions allocated for transmission of the one or more RACH preambles based on a lack of corresponding uplink transmission occasions for the one or more PUSCHs when the quantity of uplink transmission occasions is increased.

In some examples, the UE 115-b may receive an indication to increase a quantity of the uplink transmission occasions allocated for transmission of the one or more RACH preambles, the one or more PUSCHs, or both, via the one or more second messages, a system information message, or both. In some implementations, the modification of the at least one parameter increases a quantity of the uplink transmission occasions allocated for transmission of the one or more RACH preambles and for the one or more PUSCHs, and the modification of the at least one parameter maintains or modifies a quantity of DMRS sequences associated with transmission of the one or more PUSCHs.

In some other examples, the modification of the at least one parameter may decrease the quantity of the uplink transmission occasions allocated for transmission of the one or more RACH preambles. For example, the decrease in the quantity of uplink transmission occasions may be based on a modification to an uplink transmission occasion periodicity, a configuration index modification, a muting pattern modification, or any combination thereof. In some other examples, the decrease in the quantity of the uplink transmission occasions may be based on an exclusion of a slot allocated for the transmission of a RACH or an exclusion of one or more of the uplink transmission occasions allocated for transmission of the one or more RACH preambles. In some other examples, the decrease in the quantity of the uplink transmission occasions may correspond to a decrease or maintenance of the uplink transmission occasions allocated for transmission of the one or more PUSCHs that correspond to the one or more RACH preambles.

In some implementations, the modification of the at least one parameter includes an increase in a quantity of the uplink transmission occasions allocated for transmission of the one or more PUSCHs based on a corresponding increase in a quantity of DMRS sequences, DMRS ports, a per-slot quantity of uplink shared channel transmission occasions, a total quantity of uplink shared channel transmission occasions, or any combination thereof. In some examples, the modification of the at least one parameter includes a decrease in a quantity of the uplink transmission occasions allocated for transmission of the one or more PUSCHs based on a maintained quantity of resource units available per uplink transmission occasion, or based on a corresponding increase in a quantity of resource units available per uplink transmission occasion, where the corresponding increase in the quantity of resource units is associated with an increased quantity of DMRS sequences, DMRS ports, or both, allocated for each uplink transmission occasion.

In some examples, the modification of the at least one parameter includes an increase in a quantity of the uplink transmission occasions allocated for transmission of the one or more PUSCHs, and the UE 115-b may map one or more previously unmapped PUSCHs to at least one uplink transmission occasion in accordance with the increase in the quantity of the uplink transmission occasions. In some examples, the modification of the at least one parameter includes a concurrent increase in the quantity of uplink transmission occasions associated with the one or more RACH preambles and for uplink transmission occasions associated with the one or more PUSCHs.

At 615, the UE 115-b may transmit one or more uplink messages in accordance with the modification of the at least one parameter based on the one or more second messages.

In some examples, the modification of the at least one parameter occurs in accordance with a modification periodicity that changes a quantity of the uplink transmission occasions allocated for transmission of the one or more RACH preambles, the one or more PUSCHs, or both, during modification intervals of the modification periodicity. In some such examples, the UE 115-b may transmit the one or more uplink messages via an uplink transmission occasion that is based on the modification periodicity.

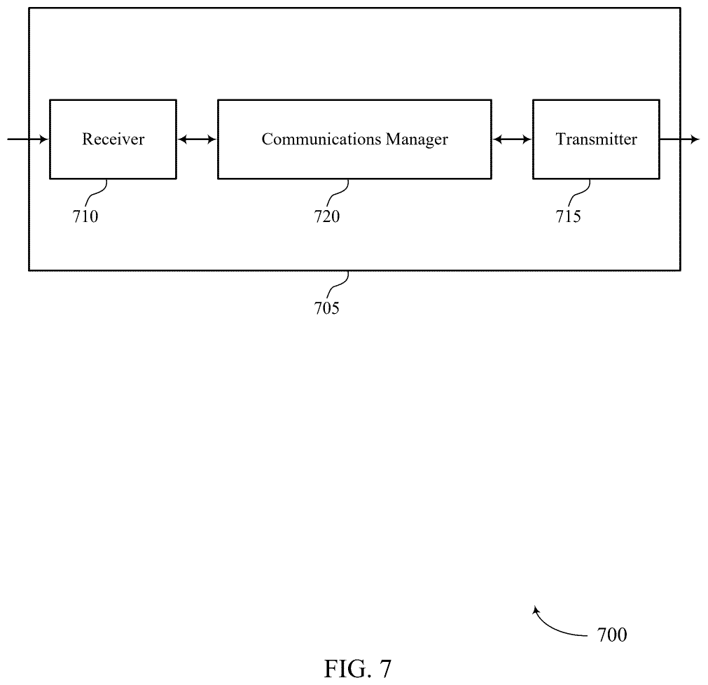

FIG. 7 shows a block diagram 700 of a device 705 that supports adaptation of RACH procedures in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to adaptation of RACH procedures). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to adaptation of RACH procedures). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of adaptation of RACH procedures as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving one or more first messages indicative of a set of parameters of a random access configuration for a two-step random access procedure for the UE, the set of parameters indicating uplink transmission occasions of the two-step random access procedure that are available for uplink transmission of one or more RACH preambles, one or more PUSCHs, or both. The communications manager 720 is capable of, configured to, or operable to support a means for receiving one or more second messages that modify at least one parameter of the set of parameters of the random access configuration, where modification of the at least one parameter modifies a configuration of the uplink transmission occasions allocated for transmission of the one or more RACH preambles, the one or more PUSCHs, or both of the two-step random access procedure. The communications manager 720 is capable of, configured to, or operable to support a means for transmitting one or more uplink messages in accordance with the modification of the at least one parameter based on the one or more second messages.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, more efficient utilization of communication resources (e.g., RACH and PUSCH resources), reduced signaling overhead, and improved device and network power savings.

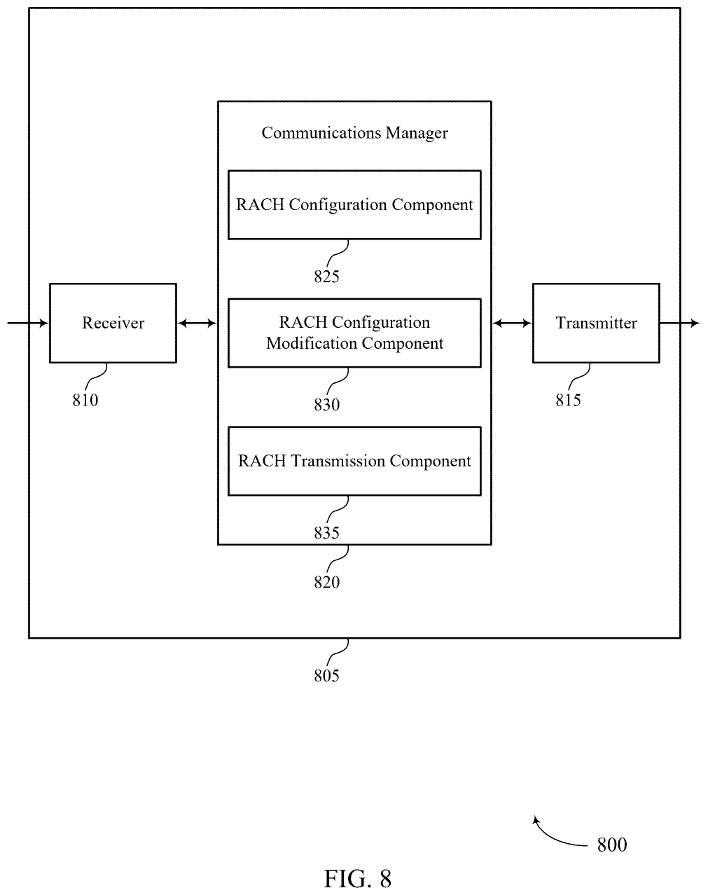

FIG. 8 shows a block diagram 800 of a device 805 that supports adaptation of RACH procedures in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to adaptation of RACH procedures). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to adaptation of RACH procedures). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of adaptation of RACH procedures as described herein. For example, the communications manager 820 may include a RACH configuration component 825, a RACH configuration modification component 830, a RACH transmission component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The RACH configuration component 825 is capable of, configured to, or operable to support a means for receiving one or more first messages indicative of a set of parameters of a random access configuration for a two-step random access procedure for the UE, the set of parameters indicating uplink transmission occasions of the two-step random access procedure that are available for uplink transmission of one or more RACH preambles, one or more PUSCHs, or both. The RACH configuration modification component 830 is capable of, configured to, or operable to support a means for receiving one or more second messages that modify at least one parameter of the set of parameters of the random access configuration, where modification of the at least one parameter modifies a configuration of the uplink transmission occasions allocated for transmission of the one or more RACH preambles, the one or more PUSCHs, or both of the two-step random access procedure. The RACH transmission component 835 is capable of, configured to, or operable to support a means for transmitting one or more uplink messages in accordance with the modification of the at least one parameter based on the one or more second messages.

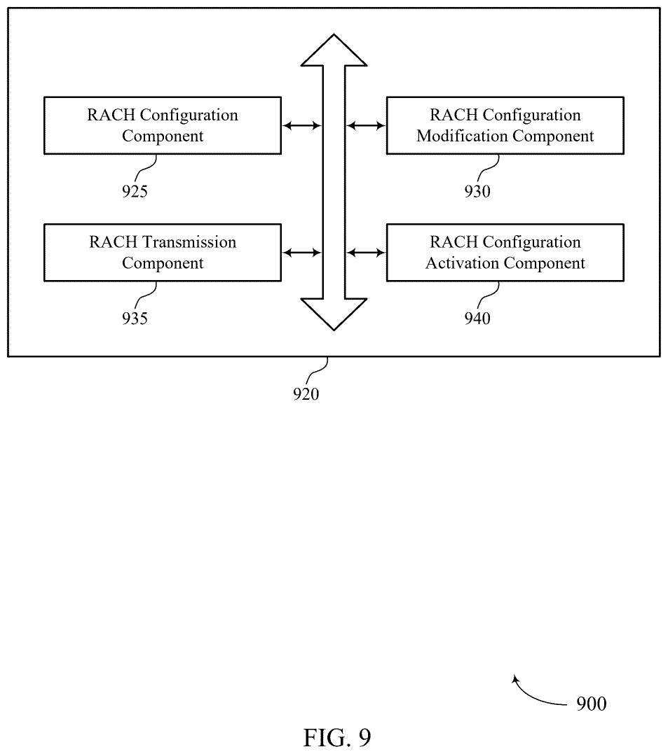

FIG. 9 shows a block diagram 900 of a communications manager 920 that supports adaptation of RACH procedures in accordance with one or more aspects of the present disclosure. The communications manager 920 may be an example of aspects of a communications manager 720, a communications manager 820, or both, as described herein. The communications manager 920, or various components thereof, may be an example of means for performing various aspects of adaptation of RACH procedures as described herein. For example, the communications manager 920 may include a RACH configuration component 925, a RACH configuration modification component 930, a RACH transmission component 935, a RACH configuration activation component 940, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The RACH configuration component 925 is capable of, configured to, or operable to support a means for receiving one or more first messages indicative of a set of parameters of a random access configuration for a two-step random access procedure for the UE, the set of parameters indicating uplink transmission occasions of the two-step random access procedure that are available for uplink transmission of one or more RACH preambles, one or more PUSCHs, or both. The RACH configuration modification component 930 is capable of, configured to, or operable to support a means for receiving one or more second messages that modify at least one parameter of the set of parameters of the random access configuration, where modification of the at least one parameter modifies a configuration of the uplink transmission occasions allocated for transmission of the one or more RACH preambles, the one or more PUSCHs, or both of the two-step random access procedure. The RACH transmission component 935 is capable of, configured to, or operable to support a means for transmitting one or more uplink messages in accordance with the modification of the at least one parameter based on the one or more second messages.

In some examples, the RACH configuration activation component 940 is capable of, configured to, or operable to support a means for receiving one or more third messages that activate the modification of the at least one parameter, where the one or more first messages include one or more semi-static configuration messages, one or more radio resource control messages, or both.

In some examples, to support transmitting the one or more uplink messages, the RACH transmission component 935 is capable of, configured to, or operable to support a means for transmitting the one or more uplink messages via an uplink transmission occasion of the uplink transmission occasions indicated by the set of parameters, where the uplink transmission occasion is based on increasing or decreasing the quantity of the uplink transmission occasions.

In some examples, to support transmitting the one or more uplink messages, the RACH transmission component 935 is capable of, configured to, or operable to support a means for transmitting at least one uplink random access message via an uplink transmission occasion of the uplink transmission occasions indicated by the set of parameters based on the modification of the at least one parameter.

In some examples, to support transmitting the one or more uplink messages, the RACH transmission component 935 is capable of, configured to, or operable to support a means for transmitting at least one uplink shared channel message via an uplink transmission occasion of the uplink transmission occasions indicated by the set of parameters based on the modification of the at least one parameter.

In some examples, to support receiving the one or more second messages that modify the at least one parameter, the RACH configuration modification component 930 is capable of, configured to, or operable to support a means for receiving the one or more second messages via one or more paging early indications, one or more downlink control information messages, one or more paging payload messages, or any combination thereof.

In some examples, to support transmitting the one or more uplink messages, the RACH transmission component 935 is capable of, configured to, or operable to support a means for transmitting the one or more uplink messages via an uplink transmission occasion of the uplink transmission occasions indicated by the set of parameters, where the uplink transmission occasion is based on the modification periodicity.

In some examples, to support transmitting the one or more uplink messages, the RACH transmission component 935 is capable of, configured to, or operable to support a means for transmitting the one or more uplink messages via an uplink transmission occasion of the uplink transmission occasions indicated by the set of parameters, where the uplink transmission occasion is based on increasing the quantity of the uplink transmission occasions.

In some examples, the modification of the at least one parameter includes an increase in a quantity of the uplink transmission occasions allocated for transmission of the one or more RACH preambles, and the RACH configuration component 925 is capable of, configured to, or operable to support a means for receiving, based on the increase in the quantity of the uplink transmission occasions allocated for transmission of the one or more RACH preambles, a system information message that indicates a configuration for a corresponding quantity of uplink transmission occasions for the one or more PUSCHs associated with the one or more RACH preambles.

In some examples, the modification of the at least one parameter includes an increase in a quantity of the uplink transmission occasions allocated for transmission of the one or more RACH preambles, and the RACH configuration component 925 is capable of, configured to, or operable to support a means for performing a four-step random access procedure for the uplink transmission occasions allocated for transmission of the one or more RACH preambles based on a lack of corresponding uplink transmission occasions for the one or more PUSCHs.

In some examples, the RACH configuration modification component 930 is capable of, configured to, or operable to support a means for receiving an indication to increase a quantity of the uplink transmission occasions allocated for transmission of the one or more RACH preambles, the one or more PUSCHs, or both, via the one or more second messages, a system information message, or both.

In some examples, to support transmitting the one or more uplink messages, the RACH transmission component 935 is capable of, configured to, or operable to support a means for transmitting the one or more uplink messages via an uplink transmission occasion of the uplink transmission occasions indicated by the set of parameters, where the uplink transmission occasion is based on increasing the quantity of the uplink transmission occasions, maintaining the quantity of DMRS sequences, or both.

In some examples, to support transmitting the one or more uplink messages, the RACH transmission component 935 is capable of, configured to, or operable to support a means for transmitting the one or more uplink messages via an uplink transmission occasion of the uplink transmission occasions indicated by the set of parameters, where the uplink transmission occasion is based on decreasing the quantity of the uplink transmission occasions.

In some examples, the decrease in the quantity of the uplink transmission occasions allocated for transmission of the one or more RACH preambles includes an exclusion of a slot allocated for the transmission of a RACH or an exclusion of one or more of the uplink transmission occasions allocated for transmission of the one or more RACH preambles.

In some examples, the decrease in the quantity of the uplink transmission occasions allocated for transmission of the one or more RACH preambles corresponds to a decrease or maintenance of the uplink transmission occasions allocated for transmission of the one or more PUSCHs that correspond to the one or more RACH preambles.

In some examples, to support transmitting the one or more uplink messages, the RACH transmission component 935 is capable of, configured to, or operable to support a means for transmitting the one or more uplink messages via an uplink transmission occasion of the uplink transmission occasions indicated by the set of parameters, where the uplink transmission occasion is based on increasing the quantity of the uplink transmission occasions.

In some examples, the modification of the at least one parameter includes a decrease in a quantity of the uplink transmission occasions allocated for transmission of the one or more PUSCHs based on a maintained quantity of resource units available per uplink transmission occasion.

In some examples, the modification of the at least one parameter includes a decrease in a quantity of the uplink transmission occasions allocated for transmission of the one or more PUSCHs based on a corresponding increase in a quantity of resource units available per uplink transmission occasion. In some examples, the corresponding increase in the quantity of resource units is associated with an increased quantity of DMRS sequences, DMRS ports, or both, allocated for each uplink transmission occasion.

In some examples, the modification of the at least one parameter includes an increase in a quantity of the uplink transmission occasions allocated for transmission of the one or more PUSCHs, and the RACH configuration modification component 930 is capable of, configured to, or operable to support a means for mapping one or more previously unmapped PUSCHs to at least one uplink transmission occasion in accordance with the increase in the quantity of the uplink transmission occasions.

In some examples, the modification of the at least one parameter includes a concurrent increase in a quantity of the uplink transmission occasions allocated for transmission of the one or more RACH preambles and a quantity of the uplink transmission occasions allocated for transmission of the one or more PUSCHs in accordance with the modification of the at least one parameter.

In some examples, the random access configuration includes a first random access configuration of a set of multiple random access configurations associated with respective features of the UE, and the RACH configuration modification component 930 is capable of, configured to, or operable to support a means for receiving a bitmap that indicates a selected random access configuration of the set of multiple random access configurations to which a modification of the set of parameters is applicable.

In some examples, a first bitmap value indicates that the modification of the set of parameters is applicable to the first random access configuration associated with a first UE feature.

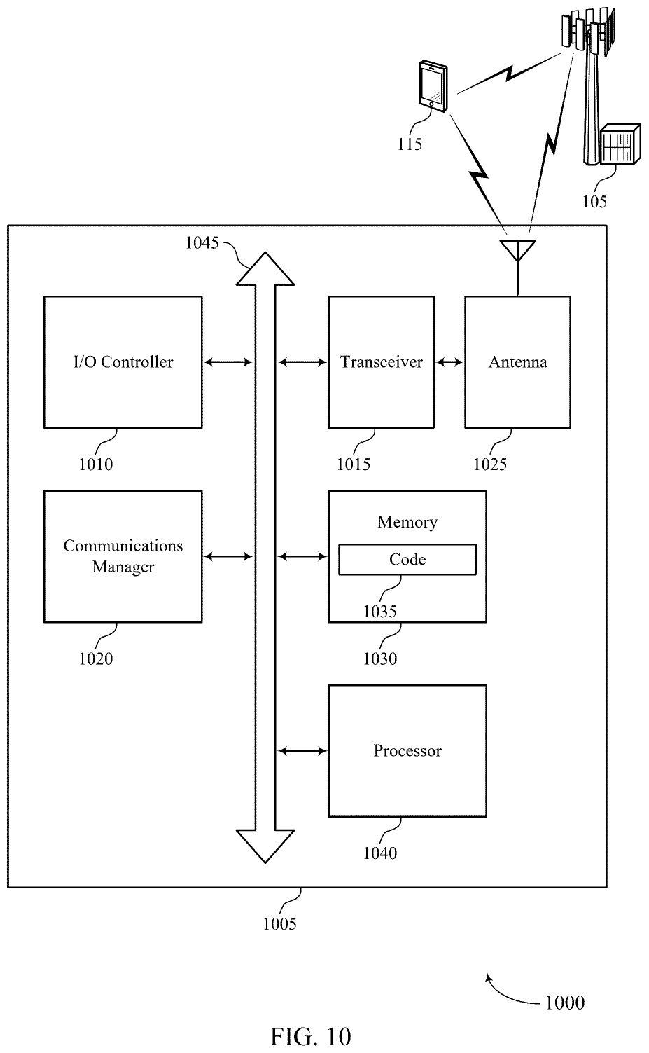

FIG. 10 shows a diagram of a system 1000 including a device 1005 that supports adaptation of RACH procedures in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting adaptation of RACH procedures). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving one or more first messages indicative of a set of parameters of a random access configuration for a two-step random access procedure for the UE, the set of parameters indicating uplink transmission occasions of the two-step random access procedure that are available for uplink transmission of one or more RACH preambles, one or more PUSCHs, or both. The communications manager 1020 is capable of, configured to, or operable to support a means for receiving one or more second messages that modify at least one parameter of the set of parameters of the random access configuration, where modification of the at least one parameter modifies a configuration of the uplink transmission occasions allocated for transmission of the one or more RACH preambles, the one or more PUSCHs, or both of the two-step random access procedure. The communications manager 1020 is capable of, configured to, or operable to support a means for transmitting one or more uplink messages in accordance with the modification of the at least one parameter based on the one or more second messages.

By including or configuring the communications manager 1020 in accordance with examples as described herein, the device 1005 may support techniques for improved communication reliability, reduced latency, improved user experience related to reduced processing, reduced power consumption at UE and network implementations, more efficient utilization of communication resources (e.g., RACH resources and PUSCH resources), improved coordination between devices, longer battery life, improved utilization of processing capability, reduced system signaling overhead, and improved device and network power savings.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of adaptation of RACH procedures as described herein, or the at least one processor 1040 and the at least one memory 1030 may be otherwise configured to, individually or collectively, perform or support such operations.

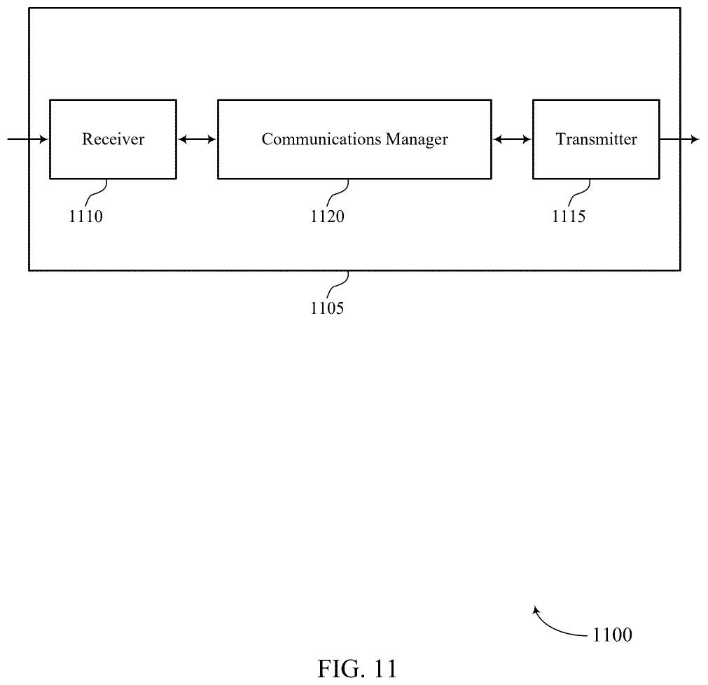

FIG. 11 shows a block diagram 1100 of a device 1105 that supports adaptation of RACH procedures in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of adaptation of RACH procedures as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting one or more first messages indicative of a set of parameters of a random access configuration for a two-step random access procedure for a UE, the set of parameters indicating uplink transmission occasions of the two-step random access procedure that are available for uplink transmission of one or more RACH preambles, one or more PUSCHs, or both. The communications manager 1120 is capable of, configured to, or operable to support a means for outputting one or more second messages that modify at least one parameter of the set of parameters of the random access configuration, where modification of the at least one parameter modifies a configuration of the uplink transmission occasions allocated for transmission of the one or more RACH preambles, the one or more PUSCHs, or both of the two-step random access procedure. The communications manager 1120 is capable of, configured to, or operable to support a means for obtaining one or more uplink messages in accordance with the modification of the at least one parameter based on the one or more second messages.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, more efficient utilization of communication resources (e.g., RACH and PUSCH resources), reduced signaling overhead, and improved device and network power savings.

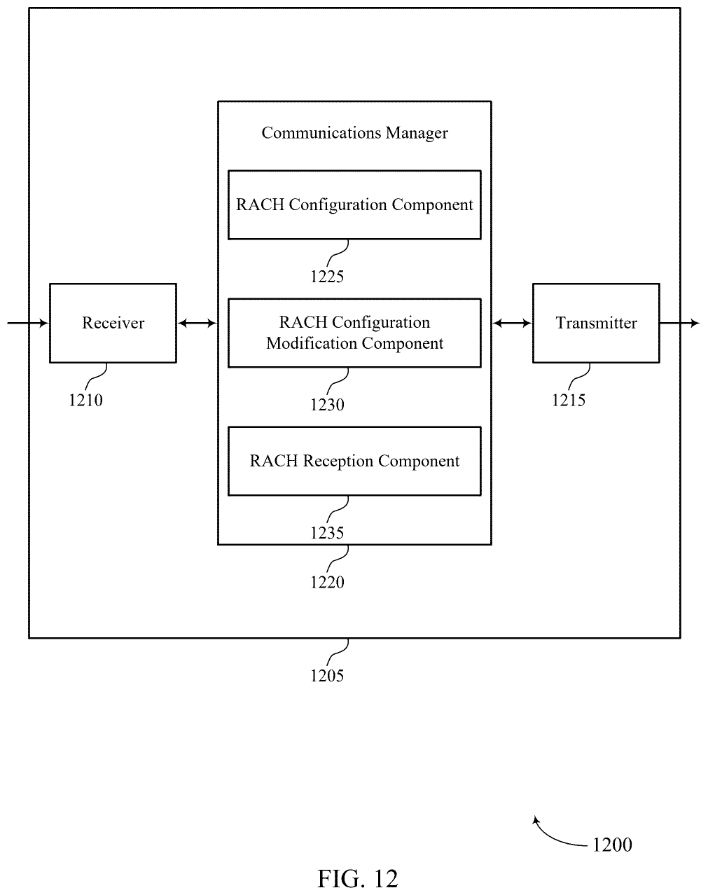

FIG. 12 shows a block diagram 1200 of a device 1205 that supports adaptation of RACH procedures in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of adaptation of RACH procedures as described herein. For example, the communications manager 1220 may include a RACH configuration component 1225, a RACH configuration modification component 1230, a RACH reception component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The RACH configuration component 1225 is capable of, configured to, or operable to support a means for outputting one or more first messages indicative of a set of parameters of a random access configuration for a two-step random access procedure for a UE, the set of parameters indicating uplink transmission occasions of the two-step random access procedure that are available for uplink transmission of one or more RACH preambles, one or more PUSCHs, or both. The RACH configuration modification component 1230 is capable of, configured to, or operable to support a means for outputting one or more second messages that modify at least one parameter of the set of parameters of the random access configuration, where modification of the at least one parameter modifies a configuration of the uplink transmission occasions allocated for transmission of the one or more RACH preambles, the one or more PUSCHs, or both of the two-step random access procedure. The RACH reception component 1235 is capable of, configured to, or operable to support a means for obtaining one or more uplink messages in accordance with the modification of the at least one parameter based on the one or more second messages.

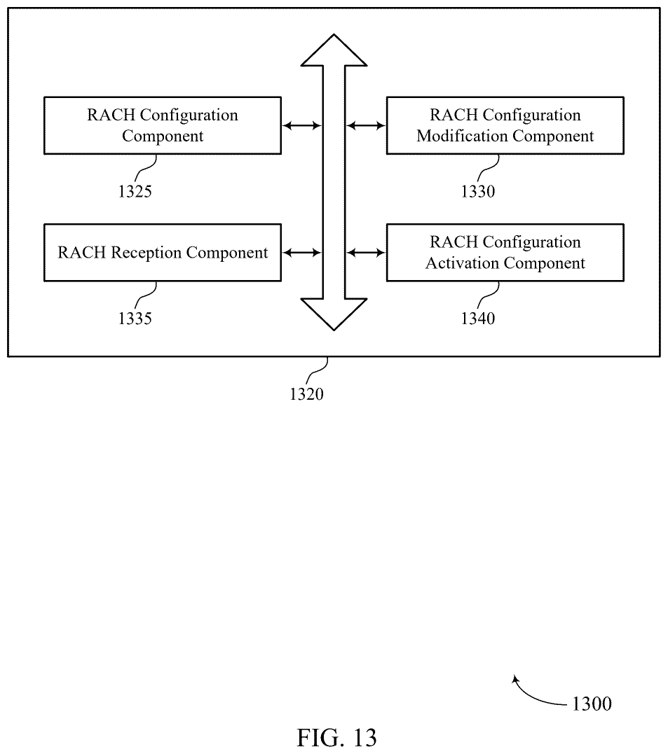

FIG. 13 shows a block diagram 1300 of a communications manager 1320 that supports adaptation of RACH procedures in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of adaptation of RACH procedures as described herein. For example, the communications manager 1320 may include a RACH configuration component 1325, a RACH configuration modification component 1330, a RACH reception component 1335, a RACH configuration activation component 1340, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The RACH configuration component 1325 is capable of, configured to, or operable to support a means for outputting one or more first messages indicative of a set of parameters of a random access configuration for a two-step random access procedure for a UE, the set of parameters indicating uplink transmission occasions of the two-step random access procedure that are available for uplink transmission of one or more RACH preambles, one or more PUSCHs, or both. The RACH configuration modification component 1330 is capable of, configured to, or operable to support a means for outputting one or more second messages that modify at least one parameter of the set of parameters of the random access configuration, where modification of the at least one parameter modifies a configuration of the uplink transmission occasions allocated for transmission of the one or more RACH preambles, the one or more PUSCHs, or both of the two-step random access procedure. The RACH reception component 1335 is capable of, configured to, or operable to support a means for obtaining one or more uplink messages in accordance with the modification of the at least one parameter based on the one or more second messages.

In some examples, the RACH configuration activation component 1340 is capable of, configured to, or operable to support a means for outputting one or more third messages that activate the modification of the at least one parameter, where the one or more first messages include one or more semi-static configuration messages, one or more radio resource control messages, or both.

In some examples, to support modification of the at least one parameter, the RACH configuration modification component 1330 is capable of, configured to, or operable to support a means for increasing or decreasing a quantity of the uplink transmission occasions allocated for transmission of the one or more RACH preambles, the one or more PUSCHs, or both of the two-step random access procedure.

In some examples, the modification of the at least one parameter includes a modification to a RACH configuration index, a modification to a RACH periodicity, an increase or decrease in a quantity of RACH occasions in a subframe, or any combination thereof.

In some examples, the modification of the at least one parameter includes a modification to a per-slot quantity of paging occasions for one or more PUSCH preambles, a modification to a quantity of slots allocated for transmission of one or more PUSCH preambles, a modification to one or more guard periods associated with transmission of one or more PUSCH preambles, a modification to a time domain offset for transmission of one or more PUSCH preambles, a start symbol and length for transmission of one or more PUSCH preambles, or any combination thereof.

In some examples, to support outputting the one or more second messages that modify the at least one parameter, the RACH configuration component 1325 is capable of, configured to, or operable to support a means for outputting the one or more second messages via one or more paging early indications, one or more downlink control information messages, one or more paging payload messages, or any combination thereof.

In some examples, the modification of the at least one parameter occurs in accordance with a modification periodicity that changes a quantity of the uplink transmission occasions allocated for transmission of the one or more RACH preambles, the one or more PUSCHs, or both, during modification intervals of the modification periodicity.

In some examples, to support modification of the at least one parameter, the RACH configuration modification component 1330 is capable of, configured to, or operable to support a means for increasing a quantity of the uplink transmission occasions allocated for transmission of the one or more RACH preambles. In some examples, to support modification of the at least one parameter, the RACH configuration modification component 1330 is capable of, configured to, or operable to support a means for increasing a corresponding quantity of uplink transmission occasions for the one or more PUSCHs associated with the one or more RACH preambles in accordance with the set of parameters of the random access configuration.

In some examples, to support modification of the at least one parameter, the RACH configuration modification component 1330 is capable of, configured to, or operable to support a means for increasing a quantity of the uplink transmission occasions allocated for transmission of the one or more RACH preambles. In some examples, to support modification of the at least one parameter, the RACH configuration modification component 1330 is capable of, configured to, or operable to support a means for outputting a system information message that indicates a configuration for a corresponding quantity of uplink transmission occasions for the one or more PUSCHs associated with the one or more RACH preambles.

In some examples, the RACH configuration modification component 1330 is capable of, configured to, or operable to support a means for outputting an indication to increase a quantity of the uplink transmission occasions allocated for transmission of the one or more RACH preambles, the one or more PUSCHs, or both, via the one or more second messages, a system information message, or both.

In some examples, modification of the at least one parameter increases a quantity of the uplink transmission occasions allocated for transmission of the one or more RACH preambles and for the one or more PUSCHs. In some examples, the modification of the at least one parameter maintains or modifies a quantity of DMRS sequences associated with transmission of the one or more PUSCHs.

In some examples, to support modification of the at least one parameter, the RACH configuration modification component 1330 is capable of, configured to, or operable to support a means for decreasing a quantity of the uplink transmission occasions allocated for transmission of the one or more RACH preambles based on a modification to an uplink transmission occasion periodicity, a configuration index modification, a muting pattern modification, or any combination thereof.

In some examples, to support decreasing the quantity of the uplink transmission occasions allocated for transmission of the one or more RACH preambles, the RACH configuration modification component 1330 is capable of, configured to, or operable to support a means for removing a slot allocated for the transmission of a RACH or removing one or more of the uplink transmission occasions allocated for transmission of the one or more RACH preambles.

In some examples, to support decreasing the quantity of the uplink transmission occasions allocated for transmission of the one or more RACH preambles, the RACH configuration modification component 1330 is capable of, configured to, or operable to support a means for decreasing or maintaining the uplink transmission occasions allocated for transmission of the one or more PUSCHs that correspond to the one or more RACH preambles based on decreasing the quantity of the uplink transmission occasions allocated for transmission of the one or more RACH preambles.

In some examples, to support modification of the at least one parameter, the RACH configuration modification component 1330 is capable of, configured to, or operable to support a means for increasing a quantity of the uplink transmission occasions allocated for transmission of the one or more PUSCHs based on a corresponding increase in a quantity of DMRS sequences, DMRS ports, a per-slot quantity of uplink shared channel transmission occasions, a total quantity of uplink shared channel transmission occasions, or any combination thereof.

In some examples, to support modification of the at least one parameter, the RACH configuration modification component 1330 is capable of, configured to, or operable to support a means for decreasing a quantity of the uplink transmission occasions allocated for transmission of the one or more PUSCHs based on a maintained quantity of resource units available per uplink transmission occasion.

In some examples, to support modification of the at least one parameter, the RACH configuration modification component 1330 is capable of, configured to, or operable to support a means for decreasing a quantity of the uplink transmission occasions allocated for transmission of the one or more PUSCHs based on a corresponding increase in a quantity of resource units available per uplink transmission occasion, where the corresponding increase in the quantity of resource units is associated with an increased quantity of DMRS sequences, DMRS ports, or both, allocated for each uplink transmission occasion.

In some examples, the random access configuration includes a first random access configuration of a set of multiple random access configurations associated with respective features of the UE, and the RACH configuration modification component 1330 is capable of, configured to, or operable to support a means for outputting a bitmap that indicates a selected random access configuration of the set of multiple random access configurations to which a modification of the set of parameters is applicable.

In some examples, a first bitmap value indicates that the modification of the set of parameters is applicable to the first random access configuration associated with a first UE feature.

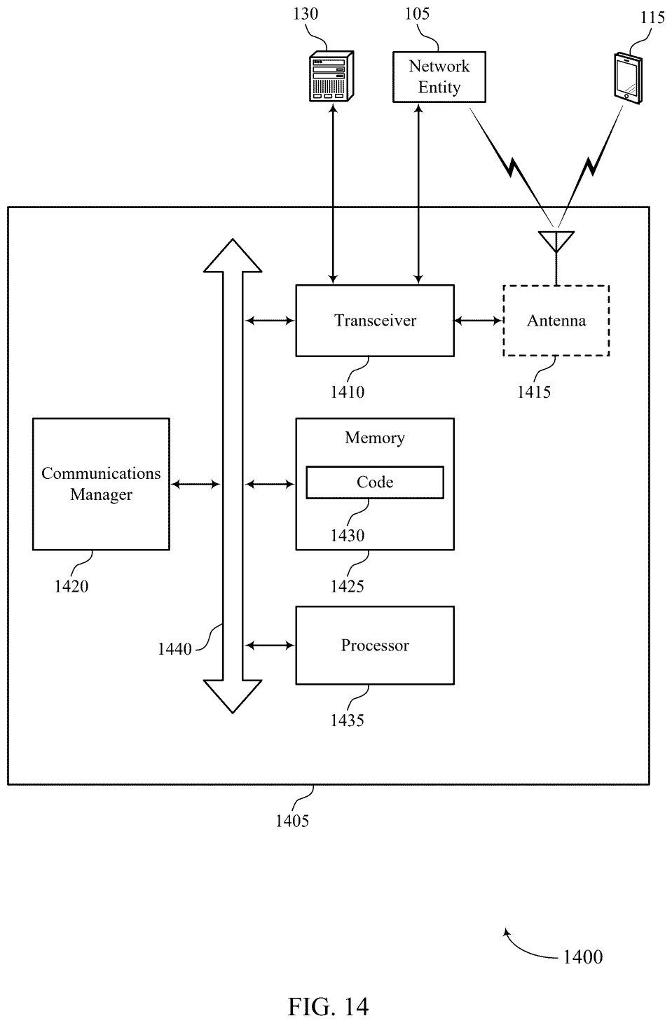

FIG. 14 shows a diagram of a system 1400 including a device 1405 that supports adaptation of RACH procedures in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting adaptation of RACH procedures). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for outputting one or more first messages indicative of a set of parameters of a random access configuration for a two-step random access procedure for a UE, the set of parameters indicating uplink transmission occasions of the two-step random access procedure that are available for uplink transmission of one or more RACH preambles, one or more PUSCHs, or both. The communications manager 1420 is capable of, configured to, or operable to support a means for outputting one or more second messages that modify at least one parameter of the set of parameters of the random access configuration, where modification of the at least one parameter modifies a configuration of the uplink transmission occasions allocated for transmission of the one or more RACH preambles, the one or more PUSCHs, or both of the two-step random access procedure. The communications manager 1420 is capable of, configured to, or operable to support a means for obtaining one or more uplink messages in accordance with the modification of the at least one parameter based on the one or more second messages.

By including or configuring the communications manager 1420 in accordance with examples as described herein, the device 1405 may support techniques for improved communication reliability, reduced latency, improved user experience related to reduced processing, reduced power consumption at UE and network implementations, more efficient utilization of communication resources (e.g., RACH resources and PUSCH resources), improved coordination between devices, longer battery life, improved utilization of processing capability, reduced system signaling overhead, and improved device and network power savings.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of adaptation of RACH procedures as described herein, or the at least one processor 1435 and the at least one memory 1425 may be otherwise configured to, individually or collectively, perform or support such operations.

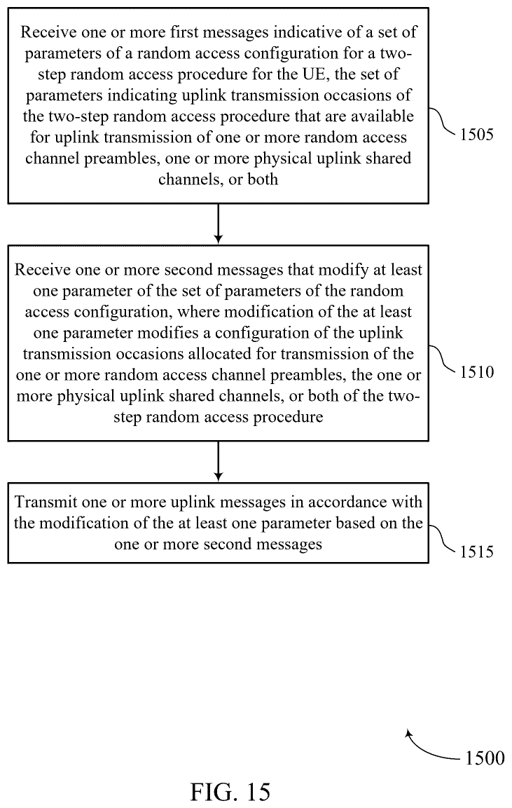

FIG. 15 shows a flowchart illustrating a method 1500 that supports adaptation of RACH procedures in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving one or more first messages indicative of a set of parameters of a random access configuration for a two-step random access procedure for the UE, the set of parameters indicating uplink transmission occasions of the two-step random access procedure that are available for uplink transmission of one or more RACH preambles, one or more PUSCHs, or both. The operations of 1505 may be performed in accordance with examples as disclosed herein. In some examples, aspects of the operations of 1505 may be performed by a RACH configuration component 925 as described with reference to FIG. 9.

At 1510, the method may include receiving one or more second messages that modify at least one parameter of the set of parameters of the random access configuration, where modification of the at least one parameter modifies a configuration of the uplink transmission occasions allocated for transmission of the one or more RACH preambles, the one or more PUSCHs, or both of the two-step random access procedure. The operations of 1510 may be performed in accordance with examples as disclosed herein. In some examples, aspects of the operations of 1510 may be performed by a RACH configuration modification component 930 as described with reference to FIG. 9.

At 1515, the method may include transmitting one or more uplink messages in accordance with the modification of the at least one parameter based on the one or more second messages. The operations of 1515 may be performed in accordance with examples as disclosed herein. In some examples, aspects of the operations of 1515 may be performed by a RACH transmission component 935 as described with reference to FIG. 9.

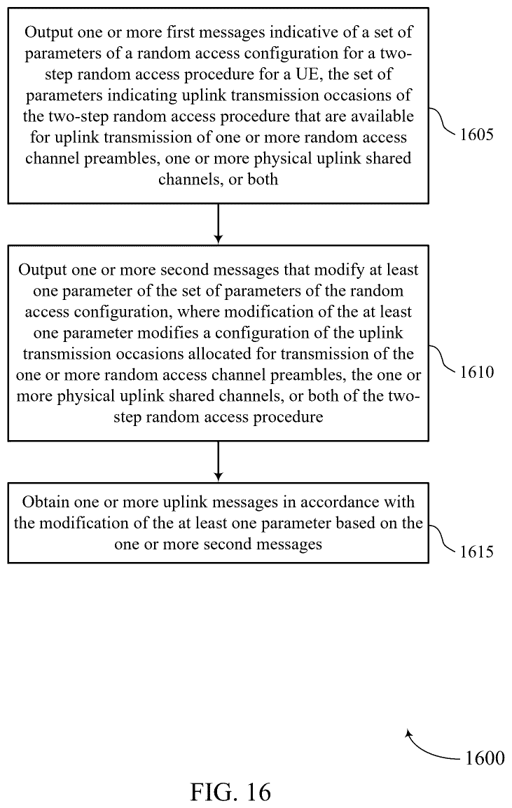

FIG. 16 shows a flowchart illustrating a method 1600 that supports adaptation of RACH procedures in accordance with one or more aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include outputting one or more first messages indicative of a set of parameters of a random access configuration for a two-step random access procedure for a UE, the set of parameters indicating uplink transmission occasions of the two-step random access procedure that are available for uplink transmission of one or more RACH preambles, one or more PUSCHs, or both. The operations of 1605 may be performed in accordance with examples as disclosed herein. In some examples, aspects of the operations of 1605 may be performed by a RACH configuration component 1325 as described with reference to FIG. 13.

At 1610, the method may include outputting one or more second messages that modify at least one parameter of the set of parameters of the random access configuration, where modification of the at least one parameter modifies a configuration of the uplink transmission occasions allocated for transmission of the one or more RACH preambles, the one or more PUSCHs, or both of the two-step random access procedure. The operations of 1610 may be performed in accordance with examples as disclosed herein. In some examples, aspects of the operations of 1610 may be performed by a RACH configuration modification component 1330 as described with reference to FIG. 13.

At 1615, the method may include obtaining one or more uplink messages in accordance with the modification of the at least one parameter based on the one or more second messages. The operations of 1615 may be performed in accordance with examples as disclosed herein. In some examples, aspects of the operations of 1615 may be performed by a RACH reception component 1335 as described with reference to FIG. 13.

The following provides an overview of aspects of the present disclosure:

Aspect 1: A method for wireless communications at a UE, comprising: receiving one or more first messages indicative of a set of parameters of a random access configuration for a two-step random access procedure for the UE, the set of parameters indicating uplink transmission occasions of the two-step random access procedure that are available for uplink transmission of one or more RACH preambles, one or more PUSCHs, or both; receiving one or more second messages that modify at least one parameter of the set of parameters of the random access configuration, wherein modification of the at least one parameter modifies a configuration of the uplink transmission occasions allocated for transmission of the one or more RACH preambles, the one or more PUSCHs, or both of the two-step random access procedure; and transmitting one or more uplink messages in accordance with the modification of the at least one parameter based at least in part on the one or more second messages.

Aspect 2: The method of aspect 1, further comprising: receiving one or more third messages that activate the modification of the at least one parameter, wherein the one or more first messages comprise one or more semi-static configuration messages, one or more RRC messages, or both.

Aspect 3: The method of any of aspects 1 through 2, wherein the modification of the at least one parameter comprises an increase or decrease in a quantity of the uplink transmission occasions allocated for transmission of the one or more RACH preambles, the one or more PUSCHs, or both, of the two-step random access procedure, and wherein transmitting the one or more uplink messages comprises: transmitting the one or more uplink messages via an uplink transmission occasion of the uplink transmission occasions indicated by the set of parameters, wherein the uplink transmission occasion is based at least in part on increasing or decreasing the quantity of the uplink transmission occasions.

Aspect 4: The method of any of aspects 1 through 3, wherein the modification of the at least one parameter comprises a modification to a RACH configuration index, a modification to a RACH periodicity, an increase or decrease in a quantity of RACH occasions in a subframe, or any combination thereof, and wherein transmitting the one or more uplink messages comprises: transmitting at least one uplink random access message via an uplink transmission occasion of the uplink transmission occasions indicated by the set of parameters based at least in part on the modification of the at least one parameter.

Aspect 5: The method of any of aspects 1 through 4, wherein the modification of the at least one parameter comprises a modification to a per-slot quantity of paging occasions for one or more PUSCH preambles, a modification to a quantity of slots allocated for transmission of one or more PUSCH preambles, a modification to one or more guard periods associated with transmission of one or more PUSCH preambles, a modification to a time domain offset for transmission of one or more PUSCH preambles, a start symbol and length for transmission of one or more PUSCH preambles, or any combination thereof, and wherein transmitting the one or more uplink messages comprises: transmitting at least one uplink shared channel message via an uplink transmission occasion of the uplink transmission occasions indicated by the set of parameters based at least in part on the modification of the at least one parameter.

Aspect 6: The method of any of aspects 1 through 5, wherein receiving the one or more second messages that modify the at least one parameter comprises: receiving the one or more second messages via one or more paging early indications, one or more DCI messages, one or more paging payload messages, or any combination thereof.

Aspect 7: The method of any of aspects 1 through 6, wherein the modification of the at least one parameter occurs in accordance with a modification periodicity that changes a quantity of the uplink transmission occasions allocated for transmission of the one or more RACH preambles, the one or more PUSCHs, or both, during modification intervals of the modification periodicity, and wherein transmitting the one or more uplink messages comprises: transmitting the one or more uplink messages via an uplink transmission occasion of the uplink transmission occasions indicated by the set of parameters, wherein the uplink transmission occasion is based at least in part on the modification periodicity.

Aspect 8: The method of any of aspects 1 through 7, wherein the modification of the at least one parameter comprises an increase in a quantity of the uplink transmission occasions allocated for transmission of the one or more RACH preambles, and an increase in a corresponding quantity of uplink transmission occasions for the one or more PUSCHs associated with the one or more RACH preambles in accordance with the set of parameters of the random access configuration, and wherein transmitting the one or more uplink messages comprises: transmitting the one or more uplink messages via an uplink transmission occasion of the uplink transmission occasions indicated by the set of parameters, wherein the uplink transmission occasion is based at least in part on increasing the quantity of the uplink transmission occasions.

Aspect 9: The method of any of aspects 1 through 8, wherein the modification of the at least one parameter comprises an increase in a quantity of the uplink transmission occasions allocated for transmission of the one or more RACH preambles, the method further comprising: receiving, based at least in part on the increase in the quantity of the uplink transmission occasions allocated for transmission of the one or more RACH preambles, a system information message that indicates a configuration for a corresponding quantity of uplink transmission occasions for the one or more PUSCHs associated with the one or more RACH preambles.

Aspect 10: The method of any of aspects 1 through 9, wherein the modification of the at least one parameter comprises an increase in a quantity of the uplink transmission occasions allocated for transmission of the one or more RACH preambles, the method further comprising: performing a four-step random access procedure for the uplink transmission occasions allocated for transmission of the one or more RACH preambles based at least in part on a lack of corresponding uplink transmission occasions for the one or more PUSCHs.

Aspect 11: The method of any of aspects 1 through 10, further comprising: receiving an indication to increase a quantity of the uplink transmission occasions allocated for transmission of the one or more RACH preambles, the one or more PUSCHs, or both, via the one or more second messages, a system information message, or both.

Aspect 12: The method of any of aspects 1 through 11, wherein modification of the at least one parameter increases a quantity of the uplink transmission occasions allocated for transmission of the one or more RACH preambles and for the one or more PUSCHs, and wherein the modification of the at least one parameter maintains or modifies a quantity of DMRS sequences associated with transmission of the one or more PUSCHs, and wherein transmitting the one or more uplink messages comprises: transmitting the one or more uplink messages via an uplink transmission occasion of the uplink transmission occasions indicated by the set of parameters, wherein the uplink transmission occasion is based at least in part on increasing the quantity of the uplink transmission occasions, maintaining the quantity of DMRS sequences, or both.

Aspect 13: The method of any of aspects 1 through 12, wherein the modification of the at least one parameter comprises a decrease in a quantity of the uplink transmission occasions allocated for transmission of the one or more RACH preambles based at least in part on a modification to an uplink transmission occasion periodicity, a configuration index modification, a muting pattern modification, or any combination thereof, and wherein transmitting the one or more uplink messages comprises: transmitting the one or more uplink messages via an uplink transmission occasion of the uplink transmission occasions indicated by the set of parameters, wherein the uplink transmission occasion is based at least in part on decreasing the quantity of the uplink transmission occasions.

Aspect 14: The method of aspect 13, wherein the decrease in the quantity of the uplink transmission occasions allocated for transmission of the one or more RACH preambles comprises an exclusion of a slot allocated for the transmission of a RACH or an exclusion of one or more of the uplink transmission occasions allocated for transmission of the one or more RACH preambles.

Aspect 15: The method of any of aspects 13 through 14, wherein the decrease in the quantity of the uplink transmission occasions allocated for transmission of the one or more RACH preambles corresponds to a decrease or maintenance of the uplink transmission occasions allocated for transmission of the one or more PUSCHs that correspond to the one or more RACH preambles.

Aspect 16: The method of any of aspects 1 through 15, wherein the modification of the at least one parameter comprises an increase in a quantity of the uplink transmission occasions allocated for transmission of the one or more PUSCHs based at least in part on a corresponding increase in a quantity of DMRS sequences, DMRS ports, a per-slot quantity of uplink shared channel transmission occasions, a total quantity of uplink shared channel transmission occasions, or any combination thereof, and wherein transmitting the one or more uplink messages comprises: transmitting the one or more uplink messages via an uplink transmission occasion of the uplink transmission occasions indicated by the set of parameters, wherein the uplink transmission occasion is based at least in part on increasing the quantity of the uplink transmission occasions.

Aspect 17: The method of any of aspects 1 through 16, wherein the modification of the at least one parameter comprises a decrease in a quantity of the uplink transmission occasions allocated for transmission of the one or more PUSCHs based at least in part on a maintained quantity of resource units available per uplink transmission occasion.

Aspect 18: The method of any of aspects 1 through 17, wherein the modification of the at least one parameter comprises a decrease in a quantity of the uplink transmission occasions allocated for transmission of the one or more PUSCHs based at least in part on a corresponding increase in a quantity of resource units available per uplink transmission occasion, the corresponding increase in the quantity of resource units is associated with an increased quantity of DMRS sequences, DMRS ports, or both, allocated for each uplink transmission occasion.

Aspect 19: The method of any of aspects 1 through 18, wherein the modification of the at least one parameter comprises an increase in a quantity of the uplink transmission occasions allocated for transmission of the one or more PUSCHs, the method further comprising: mapping one or more previously unmapped PUSCHs to at least one uplink transmission occasion in accordance with the increase in the quantity of the uplink transmission occasions.

Aspect 20: The method of any of aspects 1 through 19, wherein the modification of the at least one parameter comprises a concurrent increase in a quantity of the uplink transmission occasions allocated for transmission of the one or more RACH preambles and a quantity of the uplink transmission occasions allocated for transmission of the one or more PUSCHs in accordance with the modification of the at least one parameter.

Aspect 21: The method of any of aspects 1 through 20, wherein the random access configuration comprises a first random access configuration of a plurality of random access configurations associated with respective features of the UE, the method further comprising: receiving a bitmap that indicates a selected random access configuration of the plurality of random access configurations to which a modification of the set of parameters is applicable.

Aspect 22: The method of aspect 21, wherein a first bitmap value indicates that the modification of the set of parameters is applicable to the first random access configuration associated with a first UE feature.

Aspect 23: A method for wireless communications at a network entity, comprising: outputting one or more first messages indicative of a set of parameters of a random access configuration for a two-step random access procedure for a UE, the set of parameters indicating uplink transmission occasions of the two-step random access procedure that are available for uplink transmission of one or more RACH preambles, one or more PUSCHs, or both; outputting one or more second messages that modify at least one parameter of the set of parameters of the random access configuration, wherein modification of the at least one parameter modifies a configuration of the uplink transmission occasions allocated for transmission of the one or more RACH preambles, the one or more PUSCHs, or both of the two-step random access procedure; and obtaining one or more uplink messages in accordance with the modification of the at least one parameter based at least in part on the one or more second messages.

Aspect 24: The method of aspect 23, further comprising: outputting one or more third messages that activate the modification of the at least one parameter, wherein the one or more first messages comprise one or more semi-static configuration messages, one or more RRC messages, or both.

Aspect 25: The method of any of aspects 23 through 24, wherein the modification of the at least one parameter comprises: increasing or decreasing a quantity of the uplink transmission occasions allocated for transmission of the one or more RACH preambles, the one or more PUSCHs, or both of the two-step random access procedure.

Aspect 26: The method of any of aspects 23 through 25, wherein the modification of the at least one parameter comprises a modification to a RACH configuration index, a modification to a RACH periodicity, an increase or decrease in a quantity of RACH occasions in a subframe, or any combination thereof.

Aspect 27: The method of any of aspects 23 through 26, wherein the modification of the at least one parameter comprises a modification to a per-slot quantity of paging occasions for one or more PUSCH preambles, a modification to a quantity of slots allocated for transmission of one or more PUSCH preambles, a modification to one or more guard periods associated with transmission of one or more PUSCH preambles, a modification to a time domain offset for transmission of one or more PUSCH preambles, a start symbol and length for transmission of one or more PUSCH preambles, or any combination thereof.

Aspect 28: The method of any of aspects 23 through 27, wherein outputting the one or more second messages that modify the at least one parameter comprises: outputting the one or more second messages via one or more paging early indications, one or more DCI messages, one or more paging payload messages, or any combination thereof.

Aspect 29: The method of any of aspects 23 through 28, wherein the modification of the at least one parameter occurs in accordance with a modification periodicity that changes a quantity of the uplink transmission occasions allocated for transmission of the one or more RACH preambles, the one or more PUSCHs, or both, during modification intervals of the modification periodicity.

Aspect 30: The method of any of aspects 23 through 29, wherein the modification of the at least one parameter comprises: increasing a quantity of the uplink transmission occasions allocated for transmission of the one or more RACH preambles; and increasing a corresponding quantity of uplink transmission occasions for the one or more PUSCHs associated with the one or more RACH preambles in accordance with the set of parameters of the random access configuration.

Aspect 31: The method of any of aspects 23 through 30, wherein the modification of the at least one parameter comprises: increasing a quantity of the uplink transmission occasions allocated for transmission of the one or more RACH preambles; and outputting a system information message that indicates a configuration for a corresponding quantity of uplink transmission occasions for the one or more PUSCHs associated with the one or more RACH preambles.

Aspect 32: The method of any of aspects 23 through 31, further comprising: outputting an indication to increase a quantity of the uplink transmission occasions allocated for transmission of the one or more RACH preambles, the one or more PUSCHs, or both, via the one or more second messages, a system information message, or both.

Aspect 33: The method of any of aspects 23 through 32, wherein modification of the at least one parameter increases a quantity of the uplink transmission occasions allocated for transmission of the one or more RACH preambles and for the one or more PUSCHs, and the modification of the at least one parameter maintains or modifies a quantity of DMRS sequences associated with transmission of the one or more PUSCHs.

Aspect 34: The method of any of aspects 23 through 33, wherein the modification of the at least one parameter comprises: decreasing a quantity of the uplink transmission occasions allocated for transmission of the one or more RACH preambles based at least in part on a modification to an uplink transmission occasion periodicity, a configuration index modification, a muting pattern modification, or any combination thereof.

Aspect 35: The method of aspect 34, wherein decreasing the quantity of the uplink transmission occasions allocated for transmission of the one or more RACH preambles comprises: removing a slot allocated for the transmission of a RACH or removing one or more of the uplink transmission occasions allocated for transmission of the one or more RACH preambles.

Aspect 36: The method of any of aspects 34 through 35, wherein decreasing the quantity of the uplink transmission occasions allocated for transmission of the one or more RACH preambles comprises: decreasing or maintaining the uplink transmission occasions allocated for transmission of the one or more PUSCHs that correspond to the one or more RACH preambles based at least in part on decreasing the quantity of the uplink transmission occasions allocated for transmission of the one or more RACH preambles.

Aspect 37: The method of any of aspects 23 through 36, wherein the modification of the at least one parameter comprises: increasing a quantity of the uplink transmission occasions allocated for transmission of the one or more PUSCHs based at least in part on a corresponding increase in a quantity of DMRS sequences, DMRS ports, a per-slot quantity of uplink shared channel transmission occasions, a total quantity of uplink shared channel transmission occasions, or any combination thereof.

Aspect 38: The method of any of aspects 23 through 37, wherein the modification of the at least one parameter comprises: decreasing a quantity of the uplink transmission occasions allocated for transmission of the one or more PUSCHs based at least in part on a maintained quantity of resource units available per uplink transmission occasion.

Aspect 39: The method of any of aspects 23 through 38, wherein the modification of the at least one parameter comprises: decreasing a quantity of the uplink transmission occasions allocated for transmission of the one or more PUSCHs based at least in part on a corresponding increase in a quantity of resource units available per uplink transmission occasion, wherein the corresponding increase in the quantity of resource units is associated with an increased quantity of DMRS sequences, DMRS ports, or both, allocated for each uplink transmission occasion.

Aspect 40: The method of any of aspects 23 through 39, wherein the random access configuration comprises a first random access configuration of a plurality of random access configurations associated with respective features of the UE, the method further comprising: outputting a bitmap that indicates a selected random access configuration of the plurality of random access configurations to which a modification of the set of parameters is applicable.

Aspect 41: The method of aspect 40, wherein a first bitmap value indicates that the modification of the set of parameters is applicable to the first random access configuration associated with a first UE feature.

Aspect 42: A UE for wireless communications, comprising one or more memories storing processor-executable code, and one or more processors coupled with the one or more memories and individually or collectively operable to execute the code to cause the UE to perform a method of any of aspects 1 through 22.

Aspect 43: A UE for wireless communications, comprising at least one means for performing a method of any of aspects 1 through 22.

Aspect 44: A non-transitory computer-readable medium storing code for wireless communications, the code comprising instructions executable by one or more processors to perform a method of any of aspects 1 through 22.

Aspect 45: A network entity for wireless communications, comprising one or more memories storing processor-executable code, and one or more processors coupled with the one or more memories and individually or collectively operable to execute the code to cause the network entity to perform a method of any of aspects 23 through 41.

Aspect 46: A network entity for wireless communications, comprising at least one means for performing a method of any of aspects 23 through 41.

Aspect 47: A non-transitory computer-readable medium storing code for wireless communications, the code comprising instructions executable by one or more processors to perform a method of any of aspects 23 through 41.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more first messages indicative of a set of parameters of a random access configuration for a two-step random access procedure for the UE, the set of parameters indicating uplink transmission occasions of the two-step random access procedure that are available for uplink transmission of one or more random access channel preambles, one or more physical uplink shared channels, or both;
receive one or more second messages that modify at least one parameter of the set of parameters of the random access configuration, wherein modification of the at least one parameter modifies a configuration of the uplink transmission occasions allocated for transmission of the one or more random access channel preambles, the one or more physical uplink shared channels, or both of the two-step random access procedure; and
transmit one or more uplink messages in accordance with the modification of the at least one parameter based at least in part on the one or more second messages.

2. The UE of claim 1, wherein the one or more processors are individually or collectively further operable to execute the code to cause the UE to:
receive one or more third messages that activate the modification of the at least one parameter, wherein the one or more first messages comprise one or more semi-static configuration messages, one or more radio resource control messages, or both.

3. The UE of claim 1, wherein the modification of the at least one parameter comprises an increase or decrease in a quantity of the uplink transmission occasions allocated for transmission of the one or more random access channel preambles, the one or more physical uplink shared channels, or both, of the two-step random access procedure, and wherein, to transmit the one or more uplink messages, the one or more processors are individually or collectively operable to execute the code to cause the UE to:
transmit the one or more uplink messages via an uplink transmission occasion of the uplink transmission occasions indicated by the set of parameters, wherein the uplink transmission occasion is based at least in part on increasing or decreasing a quantity of the uplink transmission occasions.

4. The UE of claim 1, wherein the modification of the at least one parameter comprises a modification to a random access channel configuration index, a modification to a random access channel periodicity, an increase or decrease in a quantity of random access channel occasions in a subframe, or any combination thereof, and wherein, to transmit the one or more uplink messages, the one or more processors are individually or collectively operable to execute the code to cause the UE to:
transmit at least one uplink random access message via an uplink transmission occasion of the uplink transmission occasions indicated by the set of parameters based at least in part on the modification of the at least one parameter.

5. The UE of claim 1, wherein the modification of the at least one parameter comprises a modification to a per-slot quantity of paging occasions for one or more physical uplink shared channel preambles, a modification to a quantity of slots allocated for transmission of one or more physical uplink shared channel preambles, a modification to one or more guard periods associated with transmission of one or more physical uplink shared channel preambles, a modification to a time domain offset for transmission of one or more physical uplink shared channel preambles, a start symbol and length for transmission of one or more physical uplink shared channel preambles, or any combination thereof, and wherein, to transmit the one or more uplink messages, the one or more processors are individually or collectively operable to execute the code to cause the UE to:
transmit at least one uplink shared channel message via an uplink transmission occasion of the uplink transmission occasions indicated by the set of parameters based at least in part on the modification of the at least one parameter.

6. The UE of claim 1, wherein, to receive the one or more second messages that modify the at least one parameter, the one or more processors are individually or collectively operable to execute the code to cause the UE to:
receive the one or more second messages via one or more paging early indications, one or more downlink control information messages, one or more paging payload messages, or any combination thereof.

7. The UE of claim 1, wherein the modification of the at least one parameter occurs in accordance with a modification periodicity that changes a quantity of the uplink transmission occasions allocated for transmission of the one or more random access channel preambles, the one or more physical uplink shared channels, or both, during modification intervals of the modification periodicity, and wherein, to transmit the one or more uplink messages, the one or more processors are individually or collectively operable to execute the code to cause the UE to:
transmit the one or more uplink messages via an uplink transmission occasion of the uplink transmission occasions indicated by the set of parameters, wherein the uplink transmission occasion is based at least in part on the modification periodicity.

8. The UE of claim 1, wherein the modification of the at least one parameter comprises an increase in a quantity of the uplink transmission occasions allocated for transmission of the one or more random access channel preambles, and an increase in a corresponding quantity of uplink transmission occasions for the one or more physical uplink shared channels associated with the one or more random access channel preambles in accordance with the set of parameters of the random access configuration, and wherein, to transmit the one or more uplink messages, the one or more processors are individually or collectively operable to execute the code to cause the UE to:
transmit the one or more uplink messages via an uplink transmission occasion of the uplink transmission occasions indicated by the set of parameters, wherein the uplink transmission occasion is based at least in part on increasing the quantity of the uplink transmission occasions.

9. The UE of claim 1, wherein the modification of the at least one parameter comprises an increase in a quantity of the uplink transmission occasions allocated for transmission of the one or more random access channel preambles, and the one or more processors are individually or collectively further operable to execute the code to cause the UE to:
receive, based at least in part on the increase in the quantity of the uplink transmission occasions allocated for transmission of the one or more random access channel preambles, a system information message that indicates a configuration for a corresponding quantity of uplink transmission occasions for the one or more physical uplink shared channels associated with the one or more random access channel preambles.

10. The UE of claim 1, wherein the modification of the at least one parameter comprises an increase in a quantity of the uplink transmission occasions allocated for transmission of the one or more random access channel preambles, and the one or more processors are individually or collectively further operable to execute the code to cause the UE to:
perform a four-step random access procedure for the uplink transmission occasions allocated for transmission of the one or more random access channel preambles based at least in part on a lack of corresponding uplink transmission occasions for the one or more physical uplink shared channels.

11. The UE of claim 1, wherein the one or more processors are individually or collectively further operable to execute the code to cause the UE to:
receive an indication to increase a quantity of the uplink transmission occasions allocated for transmission of the one or more random access channel preambles, the one or more physical uplink shared channels, or both, via the one or more second messages, a system information message, or both.

12. The UE of claim 1, wherein modification of the at least one parameter increases a quantity of the uplink transmission occasions allocated for transmission of the one or more random access channel preambles and for the one or more physical uplink shared channels, and wherein the modification of the at least one parameter maintains or modifies a quantity of demodulation reference signal sequences associated with transmission of the one or more physical uplink shared channels, and wherein, to transmit the one or more uplink messages, the one or more processors are individually or collectively operable to execute the code to cause the UE to:
transmit the one or more uplink messages via an uplink transmission occasion of the uplink transmission occasions indicated by the set of parameters, wherein the uplink transmission occasion is based at least in part on increasing the quantity of the uplink transmission occasions, maintaining the quantity of demodulation reference signal sequences, or both.

13. The UE of claim 1, wherein the modification of the at least one parameter comprises a decrease in a quantity of the uplink transmission occasions allocated for transmission of the one or more random access channel preambles based at least in part on a modification to an uplink transmission occasion periodicity, a configuration index modification, a muting pattern modification, or any combination thereof, and wherein, to transmit the one or more uplink messages, the one or more processors are individually or collectively operable to execute the code to cause the UE to:
transmit the one or more uplink messages via an uplink transmission occasion of the uplink transmission occasions indicated by the set of parameters, wherein the uplink transmission occasion is based at least in part on decreasing the quantity of the uplink transmission occasions.

14. The UE of claim 13, wherein the decrease in the quantity of the uplink transmission occasions allocated for transmission of the one or more random access channel preambles comprises an exclusion of a slot allocated for the transmission of a random access channel or an exclusion of one or more of the uplink transmission occasions allocated for transmission of the one or more random access channel preambles.

15. The UE of claim 13, wherein the decrease in the quantity of the uplink transmission occasions allocated for transmission of the one or more random access channel preambles corresponds to a decrease or maintenance of the uplink transmission occasions allocated for transmission of the one or more physical uplink shared channels that correspond to the one or more random access channel preambles.

16. The UE of claim 1, wherein the modification of the at least one parameter comprises an increase in a quantity of the uplink transmission occasions allocated for transmission of the one or more physical uplink shared channels based at least in part on a corresponding increase in a quantity of demodulation reference signal sequences, demodulation reference signal ports, a per-slot quantity of uplink shared channel transmission occasions, a total quantity of uplink shared channel transmission occasions, or any combination thereof, and wherein, to transmit the one or more uplink messages, the one or more processors are individually or collectively operable to execute the code to cause the UE to:
transmit the one or more uplink messages via an uplink transmission occasion of the uplink transmission occasions indicated by the set of parameters, wherein the uplink transmission occasion is based at least in part on increasing the quantity of the uplink transmission occasions.

17. The UE of claim 1, wherein the modification of the at least one parameter comprises a decrease in a quantity of the uplink transmission occasions allocated for transmission of the one or more physical uplink shared channels based at least in part on a maintained quantity of resource units available per uplink transmission occasion.

18. The UE of claim 1, wherein the modification of the at least one parameter comprises a decrease in a quantity of the uplink transmission occasions allocated for transmission of the one or more physical uplink shared channels based at least in part on a corresponding increase in a quantity of resource units available per uplink transmission occasion, and wherein the corresponding increase in the quantity of resource units is associated with an increased quantity of demodulation reference signal sequences, demodulation reference signal ports, or both, allocated for each uplink transmission occasion.

19. The UE of claim 1, wherein the modification of the at least one parameter comprises an increase in a quantity of the uplink transmission occasions allocated for transmission of the one or more physical uplink shared channels, and the one or more processors are individually or collectively further operable to execute the code to cause the UE to:
mapping one or more previously unmapped physical uplink shared channels to at least one uplink transmission occasion in accordance with the increase in the quantity of the uplink transmission occasions.

20. The UE of claim 1, wherein the modification of the at least one parameter comprises a concurrent increase in a quantity of the uplink transmission occasions allocated for transmission of the one or more random access channel preambles and a quantity of the uplink transmission occasions allocated for transmission of the one or more physical uplink shared channels in accordance with the modification of the at least one parameter.

21. The UE of claim 1, wherein the random access configuration comprises a first random access configuration of a plurality of random access configurations associated with respective features of the UE, and the one or more processors are individually or collectively further operable to execute the code to cause the UE to:
receive a bitmap that indicates a selected random access configuration of the plurality of random access configurations to which a modification of the set of parameters is applicable.

22. The UE of claim 21, wherein a first bitmap value indicates that the modification of the set of parameters is applicable to the first random access configuration associated with a first UE feature.

23. A network entity, comprising:
one or more memories storing processor-executable code; and
one or more processors coupled with the one or more memories and individually or collectively operable to execute the code to cause the network entity to:
output one or more first messages indicative of a set of parameters of a random access configuration for a two-step random access procedure for a user equipment (UE), the set of parameters indicating uplink transmission occasions of the two-step random access procedure that are available for uplink transmission of one or more random access channel preambles, one or more physical uplink shared channels, or both;
output one or more second messages that modify at least one parameter of the set of parameters of the random access configuration, wherein modification of the at least one parameter modifies a configuration of the uplink transmission occasions allocated for transmission of the one or more random access channel preambles, the one or more physical uplink shared channels, or both of the two-step random access procedure; and
obtain one or more uplink messages in accordance with the modification of the at least one parameter based at least in part on the one or more second messages.

24. The network entity of claim 23, wherein the one or more processors are individually or collectively further operable to execute the code to cause the network entity to:
output one or more third messages that activate the modification of the at least one parameter, wherein the one or more first messages comprise one or more semi-static configuration messages, one or more radio resource control messages, or both.

25. The network entity of claim 23, wherein, to modify the at least one parameter, the one or more processors are individually or collectively operable to execute the code to cause the network entity to:
increase or decrease a quantity of the uplink transmission occasions allocated for transmission of the one or more random access channel preambles, the one or more physical uplink shared channels, or both of the two-step random access procedure.

26. The network entity of claim 23, wherein the modification of the at least one parameter comprises a modification to a random access channel configuration index, a modification to a random access channel periodicity, an increase or decrease in a quantity of random access channel occasions in a subframe, or any combination thereof.

27. The network entity of claim 23, wherein the modification of the at least one parameter comprises a modification to a per-slot quantity of paging occasions for one or more physical uplink shared channel preambles, a modification to a quantity of slots allocated for transmission of one or more physical uplink shared channel preambles, a modification to one or more guard periods associated with transmission of one or more physical uplink shared channel preambles, a modification to a time domain offset for transmission of one or more physical uplink shared channel preambles, a start symbol and length for transmission of one or more physical uplink shared channel preambles, or any combination thereof.

28. The network entity of claim 23, wherein, to output the one or more second messages that modify the at least one parameter, the one or more processors are individually or collectively operable to execute the code to cause the network entity to:
output the one or more second messages via one or more paging early indications, one or more downlink control information messages, one or more paging payload messages, or any combination thereof.

29. A method for wireless communications at a user equipment (UE), comprising:
receiving one or more first messages indicative of a set of parameters of a random access configuration for a two-step random access procedure for the UE, the set of parameters indicating uplink transmission occasions of the two-step random access procedure that are available for uplink transmission of one or more random access channel preambles, one or more physical uplink shared channels, or both;
receiving one or more second messages that modify at least one parameter of the set of parameters of the random access configuration, wherein modification of the at least one parameter modifies a configuration of the uplink transmission occasions allocated for transmission of the one or more random access channel preambles, the one or more physical uplink shared channels, or both of the two-step random access procedure; and
transmitting one or more uplink messages in accordance with the modification of the at least one parameter based at least in part on the one or more second messages.

30. A method for wireless communications at a network entity, comprising:
outputting one or more first messages indicative of a set of parameters of a random access configuration for a two-step random access procedure for a user equipment (UE), the set of parameters indicating uplink transmission occasions of the two-step random access procedure that are available for uplink transmission of one or more random access channel preambles, one or more physical uplink shared channels, or both;
outputting one or more second messages that modify at least one parameter of the set of parameters of the random access configuration, wherein modification of the at least one parameter modifies a configuration of the uplink transmission occasions allocated for transmission of the one or more random access channel preambles, the one or more physical uplink shared channels, or both of the two-step random access procedure; and
obtaining one or more uplink messages in accordance with the modification of the at least one parameter based at least in part on the one or more second messages.
